(19) United States
(12) Patent Application Publication
(10) Pub. No.: US 2020/0019583 A1
(43) Pub. Date: Jan. 16, 2020

(54) SYSTEMS AND METHODS FOR AUTOMATED REPAIR OF WEBPAGES

(71) Applicant: University of Southern California, Los Angeles, CA (US)

(72) Inventors: William G. J. Halfond, Los Angeles, CA (US); Sonal Mahajan, Los Angeles, CA (US); Negarsadat Abolhassani, Los Angeles, CA (US); Phil McMinn, Los Angeles, CA (US); Abdulmajeed Alameer, Los Angeles, CA (US)

(21) Appl. No.: 16/033,078

(22) Filed: Jul. 11, 2018

(51) Int. Cl. G06F 16/957; G06F 17/21; G06F 16/958; G06F 16/906; G06F 17/22

(52) U.S. Cl. CPC G06F 16/9577; G06F 17/212; G06F 17/2288; G06F 16/986; G06F 16/906; G06F 17/214

(57) ABSTRACT

Methods, systems, and apparatus for identifying display issues with a website, and automatically repairing the display issues with the website. The display issue may be an internationalization issue, a cross-browser issue, or a mobile-friendly issue. The display issues are automatically detected by analyzing the structure of the website layout. Possible fixes are determined using iterative testing, and they are evaluated using a fitness function representing a quantitative value of the display of the website. When a best fix is determined, the website is automatically repaired according to the best fix.

### GOVERNMENT LICENSE RIGHTS

This invention was made with government support under Grant No. CCF-1528163 awarded by the National Science Foundation. The government has certain rights in the disclosure.

### BACKGROUND

### 1. Field

This specification relates to a system and a method for automatically repairing a webpage being rendered improperly.

### 2. Description of the Related Art

Internationalization Issues:

To more effectively communicate with a global audience, internationalization frameworks may be used for websites, which allow the websites to provide translated text or localized media content. However, because the length of translated text differs in size from text written in the original language of the page, the page's appearance can become distorted. HTML elements that are fixed in size may clip text or appear to be too large in size, while those that are not fixed can expand, contract, and move around the page in ways that are inconsistent with the rest of the page's layout. Such distortions, called Internationalization Presentation Failures (IPFs), reduce the usability of a website and affects users' impressions of the website.

Cross-Browser Issues:

A consistent cross-browser user experience is important. Layout Cross Browser Issues (XBIs) can severely undermine a website's design by causing web pages to render incorrectly in certain browsers, thereby negatively impacting users' impression of the website.

Mobile-Friendly Issues:

Mobile devices have become a primary means of accessing the Internet. Unfortunately, many websites are not designed to be mobile friendly. This results in problems such as unreadable text, cluttered navigation, and content overflowing a device's viewport; all of which can lead to a frustrating and poor user experience. Existing techniques are limited in helping developers repair these mobile friendly problems.

### SUMMARY

What is described is a method for repairing an internationalization presentation failure in a webpage when translating the webpage from a first language to a second language. The method includes grouping elements of the webpage into sets of stylistically similar elements. The method also includes determining one or more potentially faulty elements in the webpage translated to the second language which are potential causes of the internationalization presentation failure. The method also includes determining one or more potentially faulty sets from the sets of stylistically similar elements, the one or more potentially faulty sets containing the one or more potentially faulty elements in the webpage. The method also includes determining candidate solutions comprising adjustments to a plurality of cascading style sheet (CSS) properties of the one or more faulty sets. The method also includes determining an optimized candidate solution from the candidate solutions. The method also includes automatically applying the optimized candidate solution to the website to automatically generate a repaired version of the website translated into the second language.

Also described is a method for repairing cross browser issues of a website resulting from a one or more layout differences between an intended layout rendered on a first web browser and a faulty layout rendered on a second web browser. The method includes detecting the one or more layout differences between the intended layout and the faulty layout of the website. The method also includes identifying, for each of the one or more layout differences, a plurality of root causes of the layout difference. The method also includes determining, for each of the identified root causes, a candidate fix that reduces the layout difference, such that a plurality of candidate fixes for addressing the one or more layout differences is determined. The method also includes determining an optimized combination of candidate fixes from the plurality of candidate fixes that most reduces the one or more layout differences. The method also includes automatically applying the optimized combination of candidate fixes to the website to automatically generate a repaired version of the website.

Also described is a method for repairing display and usability issues in a webpage when viewed on a mobile device. The method includes identifying one or more segments present in the webpage. The method also includes identifying one or more elements in each of the one or more segments that are causing the display and usability issues in the webpage when viewed on the mobile device. The method also includes identifying cascading style sheet (CSS) properties associated with the one or more identified elements. The method also includes determining a set of possible adjustments to the CSS properties associated with the one or more identified elements that resolve at least a portion of the display and usability issues. The method also includes determining an optimized adjustment from the set of possible adjustments. The method also includes automatically applying the optimized adjustment to the website to automatically generate a repaired version of the website.

### BRIEF DESCRIPTION OF THE DRAWINGS

Other systems, methods, features, and advantages of the present invention will be apparent to one skilled in the art upon examination of the following figures and detailed description. Component parts shown in the drawings are not necessarily to scale, and may be exaggerated to better illustrate the important features of the present invention.

FIG. 1 illustrates a computing device to be used by the system, according to various embodiments of the invention.

FIGS. 2A-2D illustrate various versions of a portion of a webpage illustrating internationalization presentation failures, according to various embodiments of the invention.

FIG. 3 illustrates an example process of automatically repairing internationalization presentation failures, according to various embodiments of the invention.

FIG. 4 illustrates an example of an ancestor element adjustment affecting a child element, according to various embodiments of the invention.

FIG. 5 illustrates a process of initializing the population of candidate solutions, according to various embodiments of the invention.

FIG. 6 illustrates a table of real-world subject web pages used in empirical evaluation, according to various embodiments of the invention.

FIG. 7 illustrates example of an equivalence class from an example subject, according to various embodiments of the invention.

FIG. 8 illustrates appearance similarity ratings given by study participants for each of the IPFs in FIG. 6, according to various embodiments of the invention.

FIG. 9 illustrates a weighted distribution of ratings, according to various embodiments of the invention.

FIGS. 10A-10C illustrate an example cross browser issue and its effect on the appearance of a webpage, according to various embodiments of the invention.

FIG. 11 illustrates a process for search-based cross browser issue repair, according to various embodiments of the invention.

FIGS. 12A-12C illustrate example layout deviation aspects between two browsers, according to various embodiments of the invention.

FIG. 13A illustrates a table of real-world subject webpages used in empirical evaluation, according to various embodiments of the invention.

FIG. 13B illustrates the number of cross browser issues in the real-world subject webpages of FIG. 13A, according to various embodiments of the invention.

FIG. 13C illustrates the average run time results for each subject webpage, according to various embodiments of the invention.

FIG. 14 illustrates the distribution of the participant ratings for each of the subject webpages, according to various embodiments of the invention.

FIG. 15 illustrates a box plot for browser specific code size for the subject webpages, according to various embodiments of the invention.

FIG. 16 illustrates a process of repairing mobile friendly issues of a webpage, according to various embodiments of the invention.

FIGS. 17A-17C illustrates segments of a webpage illustrating mobile friendly issues, according to various embodiments of the invention.

FIG. 18 illustrates a table of real-world subject webpages used in empirical evaluation, according to various embodiments of the invention.

FIG. 19 illustrates the results of comparing the before and after median mobile friendliness scores for each subject webpage, according to various embodiments of the invention.

FIG. 20 illustrates a breakdown of the average time for the different stages of the process of repairing a mobile friendly issue, according to various embodiments of the invention.

### DETAILED DESCRIPTION

Proper functioning and display of a website is crucial to the success of the company, organization, or individual associated with the website. Websites may encounter display issues for a variety of reasons, as discussed herein. These display issues may affect the usability of the website, and may ultimately affect the company, organization, or individual associated with the website. “Website” and “webpage” are herein used interchangeably, but the systems, methods, and processes described herein address issues present in one or more webpages of a website.

Websites contain content which is accessible using a computing device. In order to view a website, a computing device (e.g., a desktop computer, a laptop computer, or a smartphone) is required. Websites did not exist in a pre-Internet world, and are necessarily tied to computer technology. The diagnosing and automatic repair of website displays, as described herein, are a computer-specific and Internet-world-specific problem, which cannot be solved using a pen and paper or the human mind. Accordingly, the systems and methods described herein for automatically identifying issues in websites and automatically repairing websites are not an abstract idea.

Further, the steps of the processes described herein illustrate steps which were not performed by human beings and are not routine, conventional, or well-known in the field of website development technology. The systems, methods, processes, and approaches described herein improve the functioning of the computing device by automatically repairing faults in the website displayed by the computing device. The systems, methods, processes, and approaches described herein also improve the experience and efficiency of interaction of the website by the user.

For example, internationalization issues may affect the layout of the webpage from being properly presented, as elements of the webpage may be distorted. Automatic repair of the internationalization issues provides an improved user interface, an improved user experience, and improves the functioning of the computing device, as the user does not have to use computing system resources to determine what the improperly displayed text is supposed to say.

In another example, cross-browser issues may prevent certain webpages from rendering correctly in certain browsers. Automatic repair of the cross-browser issues provides an improved user interface, an improved user experience, and improves the functioning of the computing device, as the user does not have to use computing system resources to determine what the improperly rendered website should look like.

In another example, mobile-friendly issues may prevent certain webpages from displaying correctly in certain browsers, and may render some features or interactive parts of the webpage inaccessible. Automatic repair of the mobile-friendly issues provides an improved user interface, an improved user experience, and improves the functioning of the computing device, as the user does not have to use computing system resources to determine what the improperly rendered website should look like.

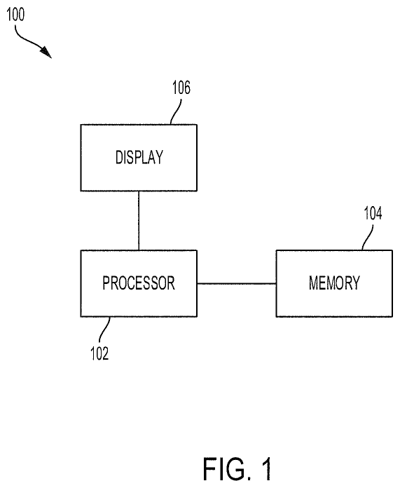

FIG. 1 illustrates an example computing device 100. The computing device 100 has a processor 102, a non-transitory memory 104, and a display 106. The processor 102 is configured to execute one or more instructions stored on the non-transitory memory 104. The processor 102 is also configured to display various images and content on the display 106. The computing device 100 may also be operatively connected to one or more other computing devices via a wired or wireless connection, and in some embodiments, via the Internet.

As will be described in further detail herein, when websites exhibit issues (e.g., internationalization issues, cross-browser issues, or mobile-friendly issues), the processor 102 may be configured to automatically identify issues in a website and automatically repair the issues in the website, as described herein. The original, faulty website may be displayed on the display 106. The automatically repaired website may also be displayed on the display 106. The computing device 100 may be used in any of the systems, methods, or approaches described herein.

Internationalization Issues:

Conventionally, developers internationalize web applications by isolating language-specific content, such as text, icons, and media, into resource files. Different sets of resource files can then be utilized depending on the user's language—a piece of information supplied by the user's browser—and inserted into placeholders in the requested page. This isolation of language specific content allows a developer to design a universal layout for a web page, easing its management and maintenance, while also modularizing language specific processing.

However, the internationalization of web pages can distort their intended layout because the length of different text segments in a page can vary depending on their language. An increase in the length of a text segment can cause it to overflow the HTML element in which it is contained, be clipped, or spill over into surrounding areas of the page. Alternatively, the containing element may expand to fit the text, which can, in turn, cause a cascading effect that disrupts the layout of other parts of the page. IPFs can affect both the usability and the aesthetics of a web page.

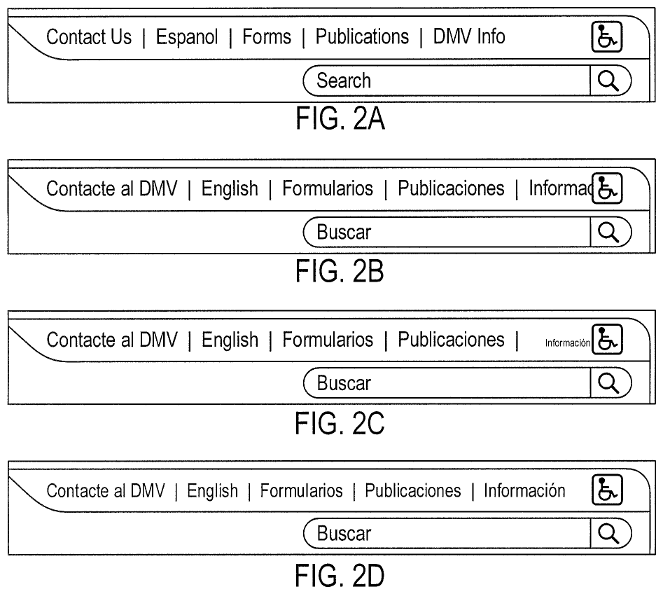

FIG. 2A illustrates a portion of a webpage that is correct and untranslated. As used herein, “correct” may refer to the layout and arrangement of elements in a webpage as intended by the webpage designer.

FIG. 2B illustrates the same portion of the webpage shown in FIG. 2A, but being translated into Spanish. The text of the page in FIG. 2A has been translated, but the increased number of characters required by the translated text pushes the final link of the navigation bar under an icon, making it difficult to read and click. Internationalization can also cause non-layout failures in web pages, such as corrupted text, inconsistent keyboard shortcuts, and incorrect/missing translations.

The complete process of debugging an IPF conventionally requires developers to (1) detect when an IPF occurs in a page, (2) localize the faulty HTML elements that are causing the IPF to appear, and (3) repair the web page by modifying CSS properties of the faulty elements to ensure that the failure no longer occurs.

In order to repair a faulty webpage, conventionally, developers changed the translation of the original text, so that the length of the translated text closely matches the original. However, this is many times not a viable solution because the translation of the text is not always under the control of developers, having typically been outsourced to professional translators or to an automatic translation service. In addition, a translation that matches the original text length may not be available. A more typical repair strategy is to adapt the layout of the internationalized page to accommodate the translation. To do this, developers identify the right sets of HTML elements and CSS properties among the potentially faulty elements, and then search for new, appropriate values for their CSS properties. Together, these new values represent a language specific CSS patch for the web page. To ensure that the patch is employed at runtime, developers use the CSS :lang( ) selector. This selector allows developers to specify alternative values for CSS properties based on the language in which the page is viewed. Although this repair strategy is relatively straightforward to understand, complex interactions among HTML elements, CSS properties, and styling rules make it challenging to find a patch that resolves all IPFs without introducing new layout problems or significantly distorting the appearance of a web UI.

The goal of the systems and methods described herein is to automatically repair IPFs that have been detected in a translated version of a web page. A translation can cause the text in a web page to expand or contract, which leads to text overflow, element movement, incorrect text wrapping, and/or misalignment.

The placement and the size of elements in a web page is controlled by their CSS properties. Therefore, these failures can be fixed by changing the value of the CSS properties of elements in a page to allow them to accommodate the new size of the text after translation.

Finding these new values for the CSS properties is complicated by several challenges. The first challenge is that any kind of style change to one element must also be mirrored in stylistically related elements. This is illustrated in FIGS. 2A-2D. To correct the overlap shown in FIG. 2B, the text size of the word “Información” can be decreased, resulting in the layout shown in FIG. 2C. However, this change is unlikely to be visually appealing to an end user since the consistency of the header appearance has been changed. The ideal change is shown in FIG. 2D, which subtly decreases the font size of all of the stylistically related elements in the header.

The second challenge is that a change for any particular IPF may introduce new layout problems into other parts of the page. This can happen when the elements surrounding the area of the IPF move to accommodate the changed size of the repaired element. This challenge is compounded when there are multiple IPFs in a page or there are many elements that must be adjusted together, since multiple changes to the page increase the likelihood that the final layout will be distorted.

The systems and methods described herein automatically identify elements that are stylistically similar through an approach that uses a clustering technique that is based on a combination of visual aspects (e.g., elements' alignment) and DOM-based metrics (e.g., XPath similarity). The approach is capable of accurately grouping stylistically similar elements that need to be changed together to maintain the aesthetic consistency of a web page's style.

The systems and methods described herein also quantify the amount of distortion introduced into a page by IPFs and use this value as a fitness function to guide a search for a set of new CSS values. The fitness function is based on detectors for IPFs and other metrics for measuring the amount of difference between two UI layouts. Therefore, the goal of the search-based approach described herein is to find a solution (i.e., new CSS values) that minimizes this fitness function.

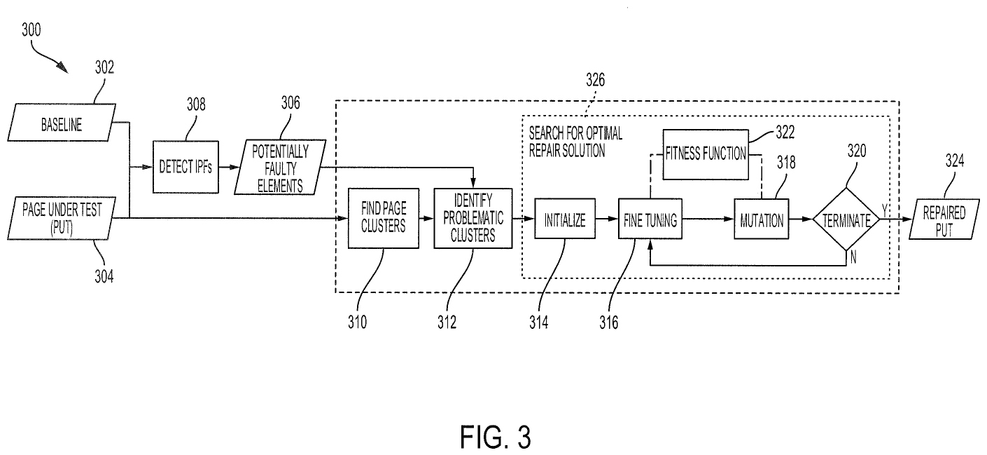

FIG. 3 illustrates an overview of the approach. The process 300 may be performed by the processor 102 of FIG. 1. The inputs to the approach are a version of the web page (labeled “baseline”) 302 that shows its correct layout, a translated version (labeled “PUT” or “Page Under Test”) 304 that exhibits IPFs, and a list 306 of HTML elements of the PUT that are likely to be faulty. The list 306 can be provided either by a detection technique 308 or manually by developers. Developers could simply provide a conservative list of possibly faulty HTML elements, but the use of an automated detection technique allows the entire process to be fully automated.

The approach begins by analyzing the PUT and automatically identifying the stylistically similar clusters that include the potentially faulty elements (step 312). Then, the approach performs a guided search to find the best CSS values for each of the identified clusters (step 326). When the search terminates, the best CSS values obtained from all of the clusters are converted to a web page CSS repair patch and provided as the output of the approach—a repaired PUT 324. Each step is described in further detail in turn.

The process identifies stylistically similar clusters (step 310). The goal of this step is to group HTML elements in the page that are visually similar into sets of stylistically similar elements, which may be referred to as SimSets. To group a page's elements into SimSets, the approach determines visual similarity and DOM information similarity between each pair of elements in the page. A distance function quantifies the similarity between each pair of elements e₁ and e₂ in the page.

Then, the approach uses a density-based clustering technique to determine which elements are in the same SimSet. After computing these SimSets, the approach identifies the SimSet associated with each faulty element reported by the automated faulty element detector (step 312). This subset of the SimSets serves as an input to the search (step 326).

Different techniques can be used to group HTML elements in a web page. A naive mechanism is to put elements having the same style class attribute into the same SimSet. However, the class attribute may not always be used by developers to set the style of similar elements, and in some cases, it is not matching for elements in the same SimSet. There are several more sophisticated techniques that may be applied to group related elements in a web page, such as Vision-based Page Segmentation (VIPS), Block-o-Matic, and RTrees. These techniques rely on elements' location in the web page and use different metrics to divide the web page into multiple segments. However, these techniques do not produce sets of visually similar elements as needed by the approach. Instead, they produce sets of web page segments that group elements that are located closely to each other and are not necessarily similar in appearance. The clustering in the approach described herein uses multiple visual aspects to group the elements, while the aforementioned techniques rely solely on the location the elements, which makes them unsuitable for the approach.

A density-based clustering technique may be used to identify stylistically similar elements in the page. A density-based clustering technique finds sets of elements that are close to each other, according to a predefined distance function, and groups them into clusters. Density-based clustering is well suited for the approach for several reasons. First, the distance function can be customized for the problem domain, which allows the approach to use style metrics instead of location. Second, this type of clustering does not require prior knowledge of the number of clusters, which is ideal for the approach since each stylistically similar group may have a different number of elements, making the total number of clusters unknown beforehand. Third, the clustering technique puts each element into only one cluster (i.e., hard clustering). This is important because if an element is placed into multiple SimSets, the search could define multiple change values for it, which may prevent the search from converging if the changes are conflicting.

The distance function may use several metrics to compute the similarity between pairs of elements in a page. These metrics may be divided into two types of similarity: (1) similarity in the visual appearance of the elements, including width, height, alignment, and CSS property values and (2) similarity in the DOM information, including XPath, HTML class attribute, and HTML tag name. DOM-related metrics are included in the distance function because only using visual similarity metrics may produce inaccurate clusters in cases where the elements belonging to a cluster are intentionally made to appear different. For example, a particular link from a list of navigational menu links may be intentionally made to look different to highlight the particular link. Since the different metrics have vastly different value ranges, the approach normalizes the value of each metric to a range [0,1], with zero representing a match for the metric and 1 being the maximum difference. The overall distance computed by the function is the weighted sum of each of the normalized metric values. In some embodiments, the metrics' weights are determined based on experimentation on a set of web pages and are the same for all subjects.

The visual similarity metrics used by the system are based on the similarity of the visual appearance of the elements. The approach uses three types of visual metrics to compute the distance between two elements e₁ and e₂—(1) elements' width and height match, (2) elements' alignment match, and (3) elements' CSS properties similarity.

Elements' width and height match is used because elements that are stylistically similar are more likely to have matching width and/or height. The approach defines width and height matching as a binary metric. For example, if the widths of the two elements e₁ and e₂ match, then the width metric value is set to 0, otherwise it is set to 1. The height metric value is computed similarly.

Elements' alignment match is used because elements that are similar are more likely to be aligned with each other. This is because browsers render a web page using a grid layout, which aligns elements belonging to the same group either horizontally or vertically. Alignment includes left edge alignment, right edge alignment, top edge alignment, and bottom edge alignment. These four alignment metrics are binary metrics, so they are computed in a way similar to the width and height metrics.

Elements' CSS properties similarity is used because aspects of the appearance of the elements in a web page, such as their color, font, and layout, are defined in the CSS properties of these elements. For this reason, elements that are stylistically similar typically have the same values for their CSS properties. The approach computes the similarity of the CSS properties as the ratio of the matching CSS values over all CSS properties defined for both elements. For this metric, the approach only considers explicitly defined CSS properties, so it does not take into account default CSS values and CSS values that are inherited from the body element in the web page. These values are matching for all elements and are not helpful in distinguishing elements of different SimSets.

The DOM information similarity metrics used by the system are based on the similarity of features defined in the DOM of the web page. The approach uses three types of DOM related metrics to compute the distance between two elements e₁ and e2—(1) elements' tag name and match, (2) elements' XPath similarity, and (3) elements' class attribute similarity.

Elements' tag name match is used because elements in the same SimSet have the same type, so the HTML tag names for them need to match. HTML tag names are used as a binary metric (e.g., if e₁ and e2 are the same tag name, then the metric value is set to 0, otherwise it is set to 1).

Elements' XPath similarity is used because elements that are in the same SimSet are more likely to have similar XPaths. The XPath similarity between two elements quantifies the commonality in the ancestry of the two elements. In HTML, elements in the page inherit CSS properties from their parent elements and pass them on to their children. More ancestors in common between two elements means more inherited styling information is shared between them. In some embodiments, the Levenshtein distance between elements' XPath is used to compute XPath distance. More formally, XPath distance is the minimum number of HTML tags edits (e.g., insertions, deletions, or substitutions) required to change one XPath into the other.

Elements' class attribute similarity is used because an HTML element's class attribute is often insufficient to group similarly styled elements. Nonetheless, it can be a useful signal; therefore class attribute similarity may be used as one of the metrics for style similarity. An HTML element can have multiple class names for the class attribute. The approach computes the similarity in class attribute as the ratio of class names that are matching over all class names that are set.

A repair for the PUT is represented as a collection of changes for each of the SimSets identified by the clustering technique. More formally, a potential repair may be defined as a candidate solution, which is a set of change tuples. Each change tuple may be of the form [symbol] S, p, Δ [symbol] where A is the change value that the approach applies to a specific CSS property p for a particular SimSet S. The change value can be positive or negative to represent an increase or decrease in the value of p. Note that a candidate solution can have multiple change tuples for the same SimSet as long as they target different CSS properties.

An example candidate solution is ( [symbol] S₁, font-size, −1 [symbol] , [symbol] S₁, width, 0 [symbol] , [symbol] S₁, height, 0 [symbol] , [symbol] S₂, font-size, −1 [symbol] , [symbol] S₂, width, 10 [symbol] , [symbol] S₂, height, 0 [symbol] ). This candidate solution represents a repair to the PUT that decreases the font-size of the elements in S1 by one pixel, decreases the font-size of the elements in S₂ by one pixel, and increases the width of the elements in S₂ by ten pixels. In these embodiments, the value “0” indicates that there is no change to the elements in the SimSet for the specified property.

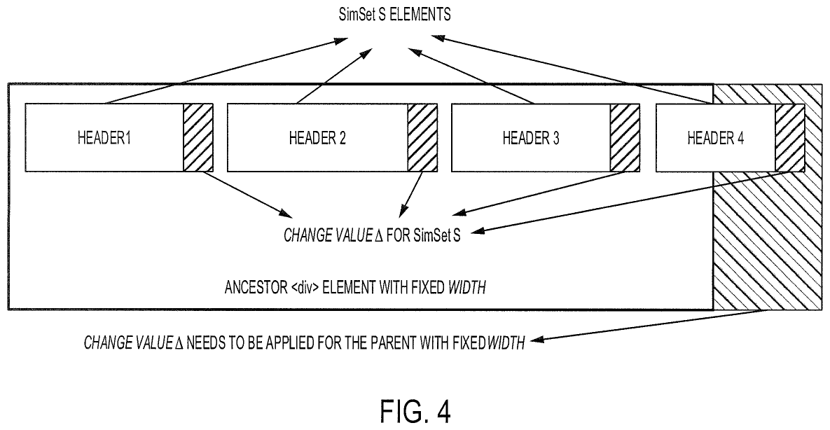

To evaluate each candidate solution, the approach first generates a PUT′ by adjusting the elements of the PUT based on the values in the candidate solution. To generate the PUT′, the approach modifies the PUT according to the values in the candidate solution that will subsequently be evaluated. The approach also modifies the width and the height of any ancestor element that has a fixed width or height that prevents the children elements from expanding freely. An example of such an ancestor element is shown in FIG. 4. In the example, increasing the width of the elements in SimSet S requires modification to the fixed width value of the ancestor div element in order to make space for the children elements' expansion.

To modify the elements that need to be changed in the PUT, the approach uses the following algorithm. The approach iterates over each change tuple [symbol] S, p, Δ [symbol] in the candidate solution and modifies the elements e ∈ S by changing their CSS property values: e.p=e.p+Δ. Then, the approach determines the cumulative increase in width and height for all the elements in S and determines the new coordinates [symbol] x1; y1 [symbol] , [symbol] x2; y2 [symbol] of the Minimum Bounding Rectangles (MBRs) of each element e. Then, the approach finds the new position of the right edge of the rightmost element max(eₓ₂), and the new position of the bottom edge of the bottommost element max(e_{y2}). After that, the approach iterates over all the ancestors of the elements in S. For each ancestor a, if a has a fixed value for the width CSS property and max(eₓ₂) is larger than aₓ₂, then the approach increases the width of the ancestor a.width=a.width+(max(eₓ₂)−aₓ₂). A similar increase is applied to the height, if the ancestor has a fixed value for the height CSS property and max(e_{y2}) is larger than a_{y2}.

As mentioned herein, a challenge in fixing IPFs is that any change to fix a particular IPF may introduce layout problems into other parts of the page. In addition, larger changes that are applied to the page make it more likely that the final layout will be distorted. This motivates the goal of the fitness function, which is to minimize the differences between the layout of the PUT and the layout of the baseline while making minimal amount of changes to the page.

To address this goal, the approach's fitness function involves two components. The first is the “Amount of Layout Inconsistency” component, which measures the impact of IPFs by quantifying the dissimilarity between the PUT′ layout and the baseline layout. The second part of the fitness function is the “Amount of Change” component, which quantifies the amount of change the candidate solution applies to the page in order to repair it. To combine the two components of the fitness function, the approach uses a prioritized fitness function model in which minimizing the amount of layout inconsistency has a higher priority than minimizing the amount of change. The amount of layout inconsistency is given higher priority because it is strongly tied with resolving the IPFs, which is the goal of the approach, while amount of change component is used after resolving the IPFs to make the changes as minimal as possible. The prioritization is done by using a sigmoid function to scale the amount of change to a fraction between 0 and 1 and adding it to the amount of layout inconsistency value. Using this, the overall fitness function is equal to amount of layout inconsistency+sigmoid(amount of change).

The “Amount of Layout Inconsistency” component represents a quantification of the dissimilarity between the baseline and the PUT′ Layout Graphs (LGs). To compute the value for this component, the approach computes the coordinates of the MBRs of each element and the inconsistencies in the PUT as reported by an automated faulty element detector. Then, the approach computes the distance (in pixels) required to make the relationships in the two LGs match. The number of pixels is computed for every inconsistent relationship reported by automated faulty element detector. For alignment inconsistencies, if two elements e₁ and e₂ are top-aligned in the baseline and not top-aligned in the PUT′, the approach computes the difference in the vertical position of the top side of the two elements |e1₁−e2_{y1}|. A similar computation is performed for bottom-alignment, right-alignment, and left-alignment.

For direction inconsistencies, if e₁ is situated to the “West” of e₂ in the baseline, and is no longer “West” in the PUT′, the approach computes the number of pixels by which e₂ needs to move to be to the West of e_{1,} which is e1ₓ₂−e2ₓ₁.

A similar computation is performed for East, North, and South relationships. For containment inconsistencies, if e1 bounds (i.e., contains) e₂ in the baseline, and no longer bounds it in the PUT′, the approach computes the vertical and horizontal expansion needed for each side of e₁'s MBR to make it bound e₂. The number of pixels computed for each of these inconsistent relationships (alignment, directional, and bounding) is added to get the total amount of layout inconsistency.

The “Amount of Change” component represents the amount of change a candidate solution causes to the page. To compute this amount, the approach calculates the percentage of change that is applied to each CSS property for every modified element in the page. The total amount of change is the summation of the squared percentages of changes. The intuition behind squaring the percentages of change is to penalize solutions more heavily if they represent a large change.

The goal of the search is to find values for the CSS properties of each SimSet that make the baseline page and the PUT have LGs that are matching with minimal changes to the page. The approach generates candidate solutions using the search operations we define in this section.

Then the approach evaluates each candidate solution it generates using the fitness function to determine if the candidate solution produces a better version of the PUT.

The approach operates by going through multiple iterations of the search. In each iteration, the approach generates a population of candidate solutions. Then, the approach refines the population by keeping only the best candidate solutions and performing the search operations on them for another iteration. The search terminates when a termination condition is satisfied. After the search terminates, the approach returns the best candidate solution in the population. More formally, the iteration includes five main steps (1) initializing the population (step 314), (2) fine-tuning the best solution using local search (step 316), (3) performing mutation (step 318), (4) selecting the best set of candidate solutions using a fitness function 322, (5) and terminating the search (step 320) if a termination condition is satisfied.

During the initializing of the population (step 314), an initial population of candidate solutions is created that the approach performs the search on. The goal of this step is to create a diverse initial population that allows the search to explore different areas of the solution space.

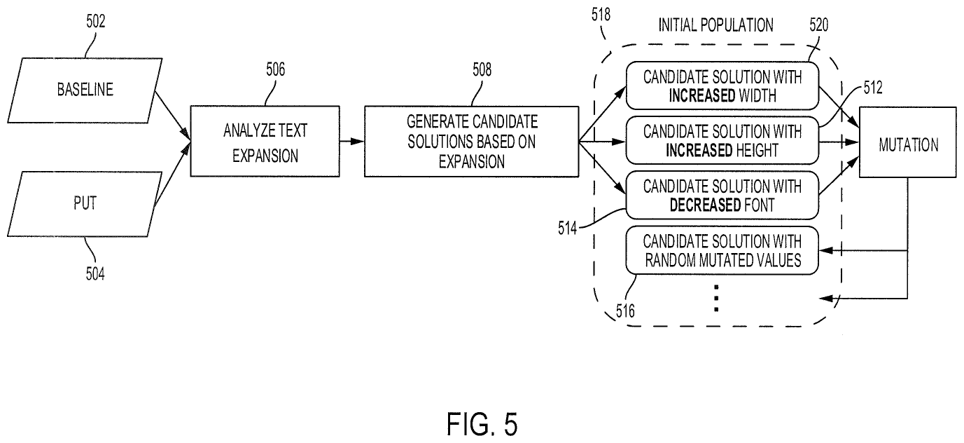

FIG. 5 shows an overview of the process of initializing the population. The inputs are a version of the web page (labeled “baseline”) 502 that shows its correct layout and a translated version (labeled “PUT” or “Page Under Test”) 504 that exhibits IPFs. The first set of candidate solutions represents modifications to the elements that are computed based on text expansion (step 506) that occurred to the PUT 504. To generate this set of candidate solutions (step 508), the approach computes the average percentage of text expansion in the elements of each SimSet that includes a faulty element. Then the approach generates three candidate solutions based on the expansion percentage, which forms the initial population 518. The first candidate solution 510 increases the width of the elements in the SimSets by a percentage equal to the percentage of the text expansion. The second candidate solution 512 increases the height by the same percentage. The third candidate solution 514 decreases the font-size of the elements in the SimSets by the same percentage. The rest of the candidate solutions 516 in the initial population 518 are generated by creating copies of the current candidate solutions and mutating the copies using the mutation operation 518 described below.

During the fine tuning (step 316), the best candidate solution in the population is selected and the change values A in it are fine tuned in order to get the best possible fix. To do this, the approach may use a local search algorithm, such as the Alternating Variable Method (AVM) local search algorithm. The approach performs local search by iterating over all the change tuples in the candidate solution and for each change tuple it tries a new value in a specific direction (i.e., it either increases or decreases the change value A for the CSS property), then evaluates the fitness of the new candidate solution to determine if it is an improvement. If there is an improvement, the search keeps trying larger values in the same direction. Otherwise, it tries the other direction. This process is repeated until the search finds the best possible change values Δ based on the fitness function. The newly generated candidate solution is added to the population.

During mutation (step 318), the population is diversified and change values that may not be reached during the AVM search are explored. The approach performs mutation operations, such as Gaussian mutation operations to the change values in the candidate solutions. It iterates over all the candidate solutions in the population and generates a new mutant for each one. The approach creates a mutant by iterating over each tuple in the candidate solution and changing its value with a probability of 1/(number of change tuples). The new change value is picked randomly from a Gaussian distribution around the old value. The newly generated candidate solutions are added to the population to be evaluated in the selection step.

The approach evaluates all of the candidate solutions in the current population and selects the best n candidate solutions, where n is the predefined size of the population. The best candidate solutions are identified based on the fitness function described herein. The selected candidate solutions are provided to the fine tuning step, and used as the population for the next iteration of the search.

The algorithm terminates (step 320) when either of two conditions are satisfied. The first condition is when a predefined maximum number of iterations is reached. This condition is used to bound the execution time of the search and prevents it from running for a long time without converging to a solution. The second condition is when the search reaches a saturation point (i.e., no improvement in the candidate solutions for multiple consecutive iterations). In this cases, the search most likely converged to the best candidate solution it could find, and further iterations will not introduce more improvement.

The repaired PUT 324 is provided, which addresses the IPFs of the PUT. For example, FIG. 2D illustrates a repaired PUT.

The automated faulty element detector is configured to automatically detect IPFs for a given webpage and identify the translated text that is responsible for the IPF.

IPFs are caused by changes in the size of translated text. Therefore, automated faulty element detector defines and builds a model, called the Layout Graph (LG), that captures the visual relationships and relative positioning of HTML tags and text elements in a web page. Two web pages are provided as input: the first is the Page Under Test (PUT) and the second is a baseline version of the page that shows the correct layout. Typically, the baseline would be the original version of the page, which is already known to be correct and will be translated to another language, as represented in the PUT. The automated faulty element detector first builds a LG for each of these pages. The automated faulty element detector then compares these two LGs and identifies differences between them that represent potentially faulty elements. Finally, the automated faulty element detector analyzes and filters these elements to produce a ranked list of elements for the developer.

The LG is a model of the visual relationships of the elements of a web page. As compared to models used in related work, such as the alignment graph and R-tree, the LG focuses on capturing the relationships of not only the HTML tags, but also the text contained within the tags. This is because the primary change to a web page after internationalization is that the text contained within the HTML tags has been translated to another language. The translated text may expand or shrink, which can cause an IPF. Therefore, the LG includes the text elements so that these changes can be more accurately modeled and compared.

An LG is a complete graph defined by the tuple [symbol] V, F [symbol] , where V is the set of nodes in the graph and F is a function F:V×V→P(R) that maps each edge to a set of visual relationships defined by R. Each node in V represents an element that has a visual impact on the page. A node is represented as a tuple [symbol] t, c₁, c₂, x [symbol] , where t is the node type and is either “Element” (i.e., an HTML tag) or “Text” (i.e., text inside of an HTML tag), c₁ is the coordinate (x₁, y₁) representing the upper left corner of the node's position on the page, c₂ is the coordinate (x₂, y₂) representing the lower right corner of the node, and x is the XPath representing the node. The two coordinates represent the Minimum Bounding Rectangle (MBR) that encloses the element or text. The set R of possible visual relationships can be broken into three categories, direction (i.e., North, South, East, West), alignment (i.e., top, bottom, left, right), and containment (i.e., contains and intersects).

In the first phase, the automated faulty element detector analyzes the PUT and baseline page to build an LG of each. The automated faulty element detector first analyzes the Document Object Model (DOM) of each page to define the LG's nodes (i.e., V) and then identifies the visual relationship between the nodes (i.e., F).

The first step of building the layout graph is to analyze the baseline page and PUT and compute the nodes in the LG. For each of these pages, this process proceeds as follows. The page is rendered in a browser, whose viewport size has been set to a predefined value. This chosen viewport size has to be the same for both pages. Then the approach uses the browser's API to traverse the page's DOM. For each HTML tag h in the DOM, the approach collects h's XPath ID (i.e., x), finds h's MBR based on the browser's rendering of h (i.e., c₁ and c₂), and assigns the type “Element” to the tag. If the node contains text (e.g., text between <p> tags or as the default value of an <input> textbox) then the approach also creates a node for the text itself. For this type of node, the XPath is the XPath of the containing node plus the suffix “/text( )”, the MBR is based on the size and shape of the text within the enclosing element, and the type is denoted as “Text.” This process is repeated for all HTML tags found in the page's DOM with three exceptions.

The first exception are HTML tags that are not visible in the page. These tags do not affect the layout of the page and therefore do not have a visual relationship with any other tag. Officially, there are specific HTML and CSS properties, such as visibility:hidden and display:none, that can be used to cause a tag to not display. Unofficially, there are a myriad of ways that a developer can hide an element. These include setting the height or width CSS properties to zero; using the clip CSS property to cut an element to a zero pixel rectangle; and setting a very high value for the text-indent property to render the element outside the boundary of its container while also setting the overflow property to hidden. The automated faulty element detector detects these and other mechanisms, and then does not create a node in the LG for the HTML tag.

The second exception is for HTML tags that do not affect the layout of the page. The tags are not explicitly hidden, as described above, but are nonetheless not visible in the page's rendering. These types of tags may be used to provide logical structure to the page. For example, a <div> may be used as a container to group other nodes. As with hidden tags, there are many ways to define these tags. Some of the heuristics we employ for this identification process are: (1) container elements that do not have a border and whose background color is similar to its parent's background color; (2) tags that have a very small dimension; (3) tags only used for text styling, such as <font>, <strong>, and <B>; and (4) tags representing an unselected option in a select menu.

The third and final exception is for HTML tags embedded in the text of another tag. Intuitively, such changes are inevitable due to translated text and should not be considered as IPFs. Therefore, the automated faulty element detector groups such tags together and creates one node in the LG for them with an MBR that surrounds all of the grouped elements and assigns to that node the type “Text.”

After computing the nodes of the graph, the second step is to define the F function, which annotates each edge in the graph with a set of visual relationships. An LG is a complete graph, so this step is computing the visual relationship between each pair of nodes on each edge. To compute the visual relationship between two nodes on an edge, the approach compares the coordinate of each node's MBR. For example, for an edge (v,w), if v.y₂≤w.y₁ then the relationship set would include North. Similarly, if v.y₂=w.y₂ then the set would include Bottom-Aligned and if (v.x₁≤w.x₁)\hat{ }(v.y₁≤w.y₁)\hat{ }(v.x₂≥w.x₂)\hat{ }(v.y₂≥w.y₂) then it would include the Contains relationship. The other relationships are computed in an analogous manner.

In the second phase, the automated faulty element detector compares the two LGs produced by the first phase in order to identify differences between them. The differences that result from the comparison represent potentially faulty tags or text that will be filtered and ranked in the third phase. A naive approach to this comparison would be to pair-wise compare the visual relationships annotating all edges in LG and LG′. The automated faulty element detector compares subgraphs of nodes and edges that are spatially close to a given node n in the LG. Comparing these more limited subgraphs of LG and LG′, which are referred to as neighborhoods, is sufficient to accurately detect IPFs and the responsible faulty elements.

Before any comparison can take place, the automated faulty element detector must identify nodes in LG and LG′ that represent the same HTML element. Although each node contains an XPath, certain translation frameworks, such as the Google Translate API, may introduce additional tags. This means that the XPaths will not be an exact match. To address this problem, a matching approach is adapted, which matches elements probabilistically using the nodes' attributes, tag names, and the Levenshtein distance between XPath IDs. This approach accounts for common variations introduced by the translation frameworks. The output of our adapted matching approach is a map M that matches each HTML tag or text in the baseline page with a corresponding tag or text in the PUT.

This matching is close to perfect because the translation API introduced regularized changes for all translated elements. After computing M, the approach then identifies the neighborhood for each n ∈ LG. To do this, the approach first computes the coordinates of the four corners and center of n's MBR. Then, for each of these five points, the approach identifies the k-Nearest Neighbors (k-NN) nodes in the LG.

The neighborhood is defined as the union of the five points' k-NNs. The closeness function in the k-NN algorithm is computed based on the spatial distance from the point to any area occupied by another node's MBR. The calculation for this is based on the classic k-NN algorithm. The approach works best when the value of k is set proportionally to the number of nodes in the LG.

The final step is to determine if the relationships assigned to edges in a neighborhood have changed. To do this, the automated faulty element detector iterates over each edge e that is part of the neighborhood of any n in LG and finds the corresponding edge e′ in LG′, using the previously generated M function. Note that the corresponding edge always exists since both LGs are complete graphs. Then the approach computes the symmetric difference between F(e) and F(e′), which identifies the visual relationships assigned to one edge but not the other. If the difference is non-empty, then the approach classifies the edge as a potential issue. The output of this step is I, a set of tuples of the form [symbol] e, e′, δ [symbol] .

In the third and final phase, the automated faulty element detector analyzes the set of tuples, I, identified in the second phase and generates a ranked list of HTML elements and text that may be responsible for the observed IPFs. To identify the most likely faulty elements, the automated faulty element detector applies three heuristics to the tuples in I and then computes a “suspiciousness” score that it uses to rank, from most suspicious to least suspicious, the nodes associated with the edges in I.

The first heuristic serves to remove edges from I that were flagged as a result of to-be-expected expansion and contraction of text. The approach identifies all edges where the type of the two constituent nodes is either Text/Element or Text/Text. If the δ of any of these edges contains alignment related relationships, then these relationships are removed from δ. If δ is now empty, then the tuple is removed from I. This heuristic only allows alignment issues to be taken into account if they affect the visual relationship between nodes that represent HTML elements.

The second heuristic establishes a method for ruling out low impact changes in the relative location of two elements. The automated faulty element detector allows users to provide a threshold that denotes the degree of allowed change. For each pair of nodes in an edge in I, if the δ of that edge contains direction related relationships, then the approach uses the coordinates of the MBRs to calculate the change (in degrees) of the angle between the two nodes forming the edge. If the change is smaller than a then these direction relationships are removed from δ. If δ is now empty, then the tuple is removed from I. α=45 provides a reasonable balance in terms of flagging changes that would be characterized as disruptive and reducing false positives.

The third and final heuristic expands the set of edges in I to include suspicious ancestor elements of nodes whose relative positions have changed. When an edge in I is found that has a directional visual relationship that has changed, the approach traverses the DOM of the page to find the Lowest Common Ancestor (LCA) of both nodes and adds an XPath selector that represents all of its text children to the list of nodes that will be ranked.

After the three heuristics have been applied to I, the automated faulty element detector generates a ranked list of the likely faulty nodes. To do this, the automated faulty element detector first creates a new set I′ that contains tuples of the form [symbol] n, s [symbol] , where n is any node present in an edge in I or identified by the third heuristic and s is a suspiciousness score, initialized to 0 for all nodes. The approach then increments the suspiciousness scores as follows: (1) every time a node n appears in an edge in I, the score of n is incremented; and (2) the score of a node n is increased by the cardinality of the difference set (i.e., |δ|). For any XPath selector that was added as a result of the third heuristic, its suspiciousness score is incremented by the number of times it is added to the list. Once the suspiciousness scores have been assigned, the approach sorts I′ in order from highest score to lowest score and reports this list to the developer. This list represents a ranking of the elements determined to be the most likely to have caused the detected IPFs.

The systems and methods described herein for automatically identifying internationalization issues in webpages and automatically repairing the identified issues must be performed by a computing device (e.g., computing device 100), as a human being could not perform the requisite computations with sufficient accuracy or precision. If a human being were to attempt to perform the methods and approaches described herein, the human being would be incapable of repairing the webpages with the efficiency, accuracy, and precision that the computing device is capable of.

To assess the effectiveness and performance of the approach of automatically repairing IPFs, empirical evaluation was conducted on 23 real-world subject web pages and answered three research questions:

RQ1: How effective is the approach in reducing IPFs?

RQ2: How long does it take for the approach to generate repairs?

RQ3: What is the quality of the fixes generated by the approach?

The approach was implemented in Java as a prototype tool named IFIX. The Apache Commons Math3 library implementation of the DBSCAN algorithm was used to group similarly styled HTML elements. Javascript and Selenium WebDriver were used for dynamically applying candidate fix values to the pages and for extracting the rendered Document Object Model (DOM) information, such as element MBRs and XPath. The jStyleParser library was used for extracting explicitly defined CSS properties for HTML elements in a page. For obtaining the set of IPFs, the latest version of GWALI was used. For the search technique described herein, the following parameter values were used: population size=100, mutation rate=1.0, max number of iterations=20, and saturation point=2. For the Gaussian distribution, used by the mutation operator, a 50% decrease and increase were used as the min and max values, and σ=(max−min)/8.0 were used as the standard deviation. For clustering, the following weights were used for the different metrics: 0.1 for width/height and alignment, 0.3 for CSS properties similarity, 0.4 for tag name, 0.3 for XPath similarity, and 0.2 for class attribute similarity.

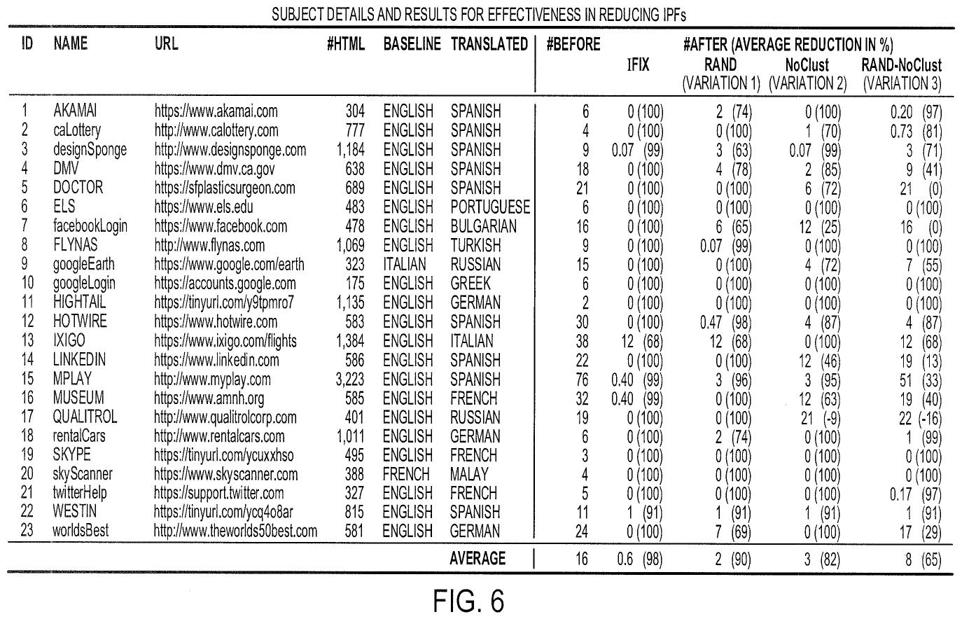

For the evaluation 23 real-world subject web pages were used, as shown in FIG. 6. The column “#HTML” shows the total number of HTML elements in the subject page, giving a rough estimate of its size and complexity. The column “Baseline” shows the language of the subject used in the baseline version that shows the correct appearance of the page, and “Translated” shows the language that exhibits IPFs in the subject with respect to the baseline. These subjects were gathered from the web pages used in the evaluation of GWALI. The main criteria behind selecting this source was the presence of known IPFs in the study of GWALI and the diversity in size, layouts, and translation languages that the GWALI subjects offered. Out of the total 54 subject pages used in the evaluation of GWALI, only those web pages for which at least one IPF was reported were filtered and selected.

Experiment One

To answer RQ1 and RQ2, IFIX was run on each subject and recorded the set of IPFs before and after each run, as reported by GWALI, and measured the total time taken. To minimize the variance in the results that can be introduced from the non-deterministic aspects of the search, IFIX was run on each subject 30 times and used the mean values across the runs in the results. To further assess and understand the effectiveness of the two main features of the work, guided search and style similarity clustering, more experiment runs were conducted with three variations to IFIX. The first variation replaced the guided search in the approach with a random search to evaluate the benefit of guided search with a fitness function. For every subject, the random search was time bounded by terminating it once the average time required by IFIX for that subject had been utilized. The second variation removed the clustering component from IFIX to evaluate the benefit of clustering stylistically similar elements in a page. The third variation combined the first and second variation. Similar to IFIX, we ran the three variations 30 times on each subject.

All of the experiments were run on a 64-bit Ubuntu 14.04 machine with 32 GB memory, Intel Core i7-4790 processor, and screen resolution of 1920×1080. For rendering the subject web pages, Mozilla Firefox v46.0.01 was used with the browser window maximized to the screen size.

For RQ1, GWALI was used to determine the initial number of IPFs in a subject and the number of IPFs remaining after each of the 30 runs. The reduction in IPFs was calculated as a percentage of the before and after values for each subject.

For RQ2, the average total running time of IFIX and variation 2 was computed across 30 runs for each subject. The performance of IFIX with its first and third variations were not compared since their random searches were time bound, as described above. The time required for the two main stages in the approach were measured; clustering stylistically similar elements and searching for a repair patch.

FIG. 6 shows the results for RQ1. The initial number of IPFs are shown under the column “#Before”. The columns headed “#After” show the average number of IPFs remaining after each of the 30 runs of IFIX for its three variations: “Rand”, “NoClust”, and “Rand-NoClust”. (Since it is an average, the results under “#After” columns may show decimal values.) The average percentage reduction is shown in parenthesis.

The results show that IFIX was the most effective in reducing the number of IPFs, with an average 98% reduction, compared to its variations. This shows the effectiveness of the approach in resolving IPFs.

The results also strongly validate the two key insights of using guided search and clustering in the approach. The first key insight was validated as IFIX was able to outperform a random search that had been given the same amount of time. The approach was substantially more successful in primarily two scenarios. First, pages (e.g., dmv and facebookLogin) containing multiple IPFs concentrated in the same area that require a careful resolution of the IPFs by balancing the layout constraints without introducing new IPFs. Second, pages (e.g., akamai) that have strict layout constraints, permitting only a very small range of CSS values to resolve the IPFs. Overall, the repairs generated by random search were not visually pleasing as they often involved a substantial reduction in the font-size of text, indicating that guidance was helpful for the approach. This observation was also reflected in the total amount of change made to a page, captured by the fitness function, which reported that random search introduced 28% more changes, on average, compared to IFIX. The second key insight of using a style-based clustering technique was validated as IFIX not only rendered the pages more visually consistent compared to its non-clustered variations, but also increased the effectiveness by resolving a relatively higher number of IPFs.

Out of the 23 subjects, IFIX was able to completely resolve all of the reported IPFs in 18 subjects in each of the 30 runs and in 21 subjects in more than 90% of the runs. The two subjects, ixigo and westin, where IFIX was not able to completely resolve all of the reported IPFs were investigated, and it was found that the dominant reason for the ixigo subject was false positive IPFs that were reported by GWALI. This occurred because the footer area of the page had significant differences in terms of layout and structure between the baseline and translated page. Therefore, CSS changes made by IFIX were not sufficient to resolve the IPFs in the footer area. For the westin subject, elements surrounding the unrepaired IPF were required to be modified in order to completely resolve it. However, these elements were not reported by GWALI, thereby precluding IFIX from finding a suitable fix.

The total running time of IFIX ranged from 73 seconds to 17 minutes, with an average of just over 4 minutes and a median of 2 minutes. IFIX was also three times faster, on average, than its second variation (no clustering). This was primarily because clustering enabled a narrowing of the search space by grouping together potentially faulty elements reported by GWALI that were also stylistically similar. Thereby a single change to the cluster was capable of resolving multiple IPFs. Moreover, the clustering overhead in IFIX was negligible, requiring less than a second, on average. Due to space limitations, the detailed timing results are omitted from the paper, but can be found at the project website.

Experiment Two

For addressing RQ3, a user study was conducted to understand the visual quality of IFIX's suggested fixes from a human perspective. The general format of the survey was to present, in random order, an IPF containing a UI snippet from a subject web page before and after repair. The participants were then asked to compare the two UI snippets on a 5-point Likert scale with respect to their appearance similarity to the corresponding UI snippet from the baseline version

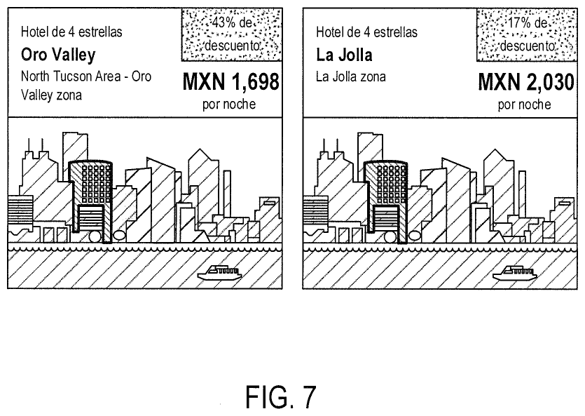

Each UI snippet showing an IPF was captured in context of its surrounding region to allow participants to view the IPF from a broader perspective. Examples of UI snippets are shown in FIG. 2B and FIG. 7. To select the “after” version of a subject, the run with the best fitness score across the 30 runs of IFIX in Experiment One was used. To figure out the number of IPFs to be shown for each subject, the IPFs reported by GWALI were manually analyzed and groups of IPFs that shared a common visual pattern were identified.

These groups were referred to as “equivalence classes”. FIG. 7 shows an example of an equivalence class from the Hotwire subject, where the two IPFs caused by the price text overflowing the container are highly similar. One IPF from each equivalence class was presented in the survey.

To make the survey length manageable for the participants, the 23 subjects were divided over five different surveys, with each containing four or five subjects. The participants of the user study were 37 undergraduate level students. Each participant was assigned to one of the five surveys. The participants were instructed to use a desktop or laptop for answering the survey to be able to view the IPF UI snippets in full resolution.

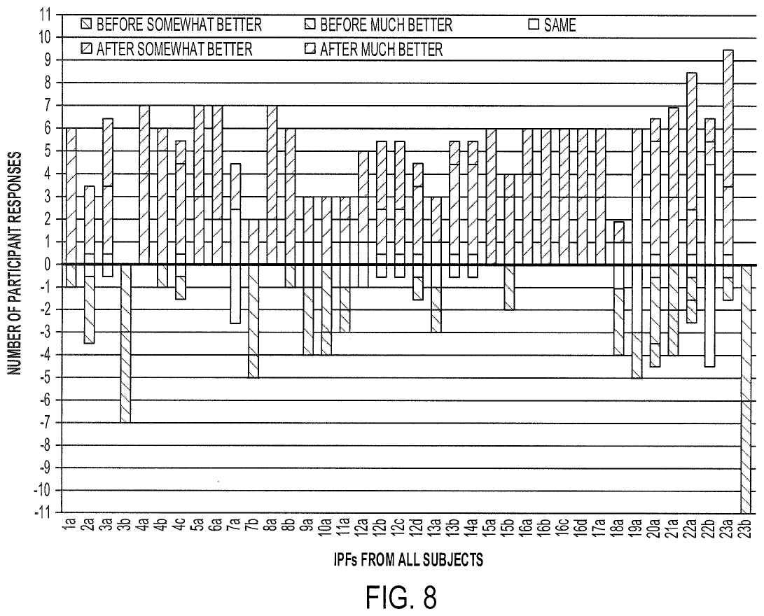

The results for the appearance similarity ratings given by the participants for each of the IPFs in the 23 subjects are shown in FIG. 8. On the x-axis, the ID and number of IPFs for a subject are shown. For example, 4a, 4b, and 4c represent the dmv subject with three IPFs. The blue colored bars above the x-axis indicate the number of ratings in favor of the after (repaired) version. The dark blue color shows participants' response for the after version being much better than the before version, while the light blue color shows the response for the after version being somewhat better than the before version. Similarly, the red bars below the X-axis indicate the number of ratings in favor of the before repair version, with dark and light red showing the response for the before version being much and somewhat better than the after version, respectively. The gray bars show the number of ratings where the participants responded that the before and after versions had the same appearance similarity to the baseline.

For example, IPF 23a had a total of 11 responses, six for the after version being much better, three for the after version being somewhat better, one reporting both the versions as the same, and one reporting the before version as being somewhat better. As can be seen from FIG. 8, 64% of the participant responses favored the after repair versions, 21% favored the before repair versions, and 15% reported both versions as the same.

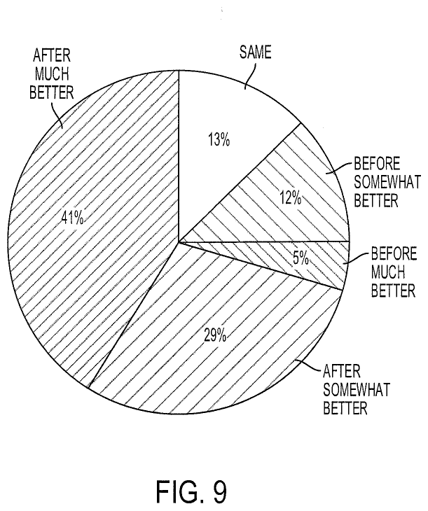

The results of the user study show that the participants largely rated the after (repaired) pages as better than the before (faulty) versions. This indicates that the approach generates repairs that are high in visual quality. The IPFs presented in the user study, however, do not comprehensively represent all of the IPFs reported for the subjects as the surveys only contained one representative from each equivalence class. Therefore the survey responses were weighted by multiplying each response from an equivalence class with the size of the class. The results are shown in FIG. 9. With the weighting, 70% responses show support for the after version. Also, interestingly, the results show the strength of support for the after version—41% of responses rate the after version as much better, while only 5% responses rate the before version as much better.

Two of the IPFs, 3b and 23b, had no participant responses in favor of the after version. These subjects were inspected in more detail and it was found that the primary reason for this was that IFIX substantially reduced the font-size (e.g., from 13 px to 5 px for 3b) to resolve the IPFs. Although these changes were visually unappealing, these extreme changes were the only way to resolve the IPFs. IPFs, 7a, 19a, and 22b also had a majority of the participant responses reporting both versions as the same.

IFIX was unable to resolve 22b, implying that the before and after versions were practically the same. The issue with 7a and 19a was slightly different. Both IPFs were caused by guidance text in an input box being clipped because the translated text exceeded the size of the input box. Unless the survey takers could understand the target language translation, there was no way to know that the guidance text was missing words.

The experiments described herein and their corresponding results demonstrate the effectiveness of the systems and methods described herein for automatically repairing IPFs of webpages in a technical, computationally-improved, and computationally-efficient manner. The experiments described herein also demonstrate that the technology being improved is technical, computer-dependent, and Internet-based technology.

Cross-Browser Issues:

The appearance of a web application's User Interface (UI) plays an important part in its success. Studies have shown that users form judgments about the trustworthiness and reliability of a company based on the visual appearance of its web pages, and that issues degrading the visual consistency and aesthetics of a web page have a negative impact on an end user's perception of the website and the quality of the services that it delivers.

The constantly increasing number of web browsers with which users can access a website has introduced new challenges in preventing appearance related issues. Differences in how various browsers interpret HTML and CSS standards can result in Cross Browser Issues (XBIs)—inconsistencies in the appearance or behavior of a website across different browsers. Although XBIs can impact the appearance or functionality of a website, the vast majority result in appearance related problems. This makes XBIs a significant challenge in ensuring the correct and consistent appearance of a website's UI.

Despite the importance of XBIs, their detection and repair poses numerous challenges for developers. First, the sheer number of browsers available to end users is large. There are at least 115 actively maintained and currently available browsers. Developers must verify that their websites render and function consistently across as many of these different browsers and platforms as possible. Second, the complex layouts and styles of modern web applications make it difficult to identify the UI elements responsible for the observed XBI. Third, developers lack a standardized way to address XBIs and generally have to resolve XBIs on a case by case basis. Fourth, for a repair, developers must modify the problematic UI elements without introducing new XBIs.

Predictably, these challenges have made XBIs an ongoing topic of concern for developers. A simple search on StackOverflow—a popular technical forum—with the search term “cross browser” results in over 23,000 posts discussing ways to resolve XBIs, of which approximately 7,000 are currently active questions. Tool support to help developers debug XBIs is limited in terms of capabilities. Although some tools can provide useful information, developers still require expertise to manually analyze the XBIs (which involves determining which HTML elements to inspect, and understanding the effects of the various CSS properties defined for them), and then repair them by performing the necessary modifications so that the page renders correctly.

To address these limitations, the systems and methods described herein use a novel search-based approach that enables the automated repair of a significant class of appearance related XBIs. The XBIs targeted by the approach are known as layout XBIs (or “structure XBIs”), which collectively refer to any XBI that relates to an inconsistent layout of HTML elements in a web page when viewed in different browsers. Layout XBIs appear in over 56% of the websites manifesting XBIs. The systems and methods described herein quantify the impact of layout XBIs using a fitness function capable of guiding a search to a repair that minimizes the number of XBIs present in a page. The approach described herein is the first automated technique for generating XBI repairs, and the first to apply search-based repair techniques to web pages.

Modern web applications typically follow the “Model-View-Controller (MVC)” design pattern in which the application code (the “Model” and “Controller”) runs on a server accessible via the Internet and delivers HTML and CSS-based web pages (the “View”) to a client running a web browser. The layout engine in a web browser is responsible for rendering and displaying the web pages. When a web browser receives a web page, the layout engine parses its HTML into a data structure called a Document Object Model (DOM) tree. Each HTML element may be referenced in the DOM tree using a unique expression, called an “XPath”.

To render a DOM tree, the layout engine calculates each DOM element's bounding box and applicable style properties based on the Cascading Style Sheets (CSS) style rules pertaining to the web page. A bounding box gives the physical display location and size of an HTML element on the browser screen.

Inconsistencies in the way browsers interpret the semantics of the DOM and CSS can cause layout XBIs—differences in the rendering of an HTML page between two or more browsers. These inconsistencies tend to arise from different interpretations of the HTML and CSS specifications, and are not per se, faults in the browsers themselves. Additionally, some browsers may implement new CSS properties or existing properties differently in an attempt to gain an advantage over competing browsers.

When a layout XBI has been detected, conventionally developers may employ several strategies to adjust its appearance. For example, developers may change the HTML structure, replace unsupported HTML tags, or adjust the page's CSS. The systems and methods described herein target XBIs that can be resolved by finding alternate values for a page's CSS properties. There are two significant challenges to carrying out this type of repair. First, the appearance (e.g., size, color, font style) of any given set of HTML elements in a browser is controlled by a series of complex interactions between the page's HTML elements and CSS properties, which means that identifying the HTML elements responsible for the XBI is challenging. Second, assuming that the right set of elements can be identified, each element may have dozens of CSS properties that control its appearance, position, and layout. Each of these properties may range over a large domain. This makes the process of identifying the correct CSS properties to modify and the correct alternate values for those properties a labor intensive, time consuming, and error prone task.

Once the right alternate values are identified, developers can use browser-specific CSS qualifiers to ensure that they are used at runtime. These qualifiers direct the layout engine to use the provided alternate values for a CSS property when it is rendered on a specific browser. This approach is widely employed by developers.

79% of the top 480 websites employ browser-specific CSS to ensure a consistent cross browser appearance. In fact, web developers typically maintain an extensive list of browser specific styling conditions to address the most common XBIs.

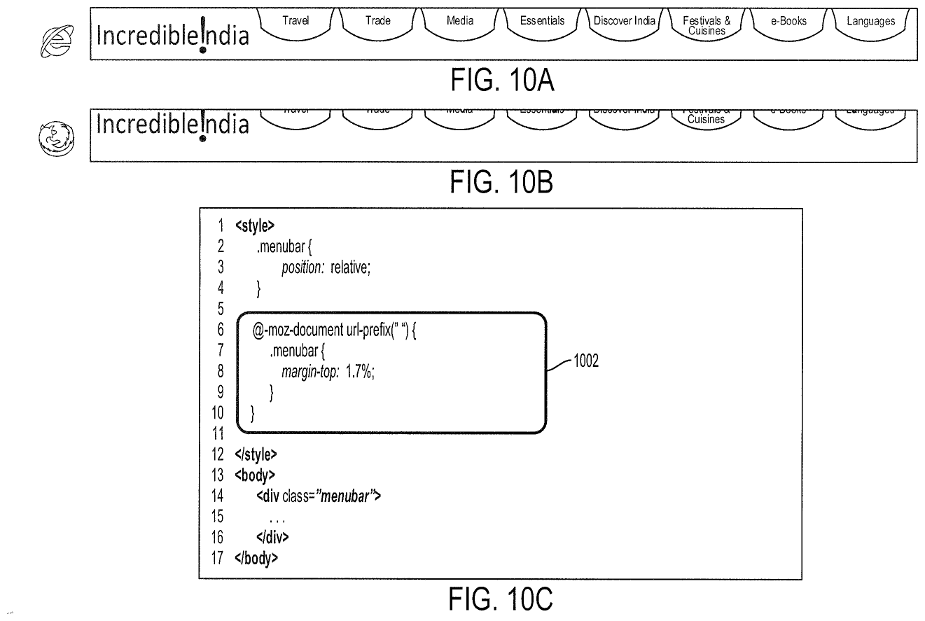

FIGS. 10A and 10B illustrate an example XBI and its effect on the appearance of a webpage. FIGS. 10A and 10B show screenshots of the menu bar of an example webpage, IncredibleIndia, as rendered in Internet Explorer® (IE) (FIG. 10A) and Firefox® (FIG. 10B). As can be seen, an XBI is present in the menu bar, where the text of the navigational links is unreadable in the Firefox® browser (FIG. 10B).

An excerpt of the HTML and CSS code that defines the navigation bar is shown in FIG. 10C. To resolve the XBI, an appropriate value for the margin-top or padding-top CSS property needs to be found for the HTML element corresponding to the navigation bar to push it down and into view. In this instance, the fix is to add “margin-top: 1.7%” to the CSS for the Firefox® version. The inserted browser-specific code is shown in the box 1002 in FIG. 10C. The “-moz” prefixed selector declaration directs the layout engine to only use the included value if the browser type is Firefox® (i.e., Mozilla®), and other browsers' layout engines will ignore this code.

While this example is straightforward and easy to explain, most XBIs are much more difficult to resolve. Typically multiple elements may need to be adjusted, and for each one multiple CSS properties may also need to be modified. A fix itself may introduce new XBIs, meaning that several alternate fixes may need to be considered.

The goal of the approach of the systems and methods described herein is to find potential fixes that can repair the layout XBIs detected in a web page. Layout XBIs result in the inconsistent placement of UI elements in a web page across different browsers. The placement of a web page's UI elements is controlled by the page's HTML elements and CSS properties. Therefore, to resolve the XBIs, the systems and methods described herein find new values for CSS properties that can make the faulty appearance match the correct appearance as closely as possible.

Formally, XBIs are due to one or more HTML-based root causes. A root cause is a tuple [symbol] e,p,v [symbol] , where e is an HTML element in the page, p is a CSS property of e, and v is the value of p. Given a set of XBIs X for a page under test (PUT) and a set of potential root causes, the systems and methods described herein seek to find a set of fixes that resolve the XBIs in X. A fix is defined as a tuple [symbol] r,v′ [symbol] , where r is a root cause and v′ is the suggested new value for p in the root cause r. A set of XBI-resolving fixes may be referred to as a repair.

The systems and methods described herein generate repairs using guided search-based techniques. Two aspects of the XBI repair problem motivate this choice of technique. The first is that the number of possible repairs is very large, since there can be multiple XBIs present in a page, each of which may have several root causes, and for which the relevant CSS properties range over a large set of possible values.

Second, fixes made for one particular XBI may interfere with those for another, or, a fix for any individual XBI may itself cause additional XBIs, requiring a tradeoff to be made among possible fixes.

Search-based techniques are well-suited for this type of problem because they can explore large solution spaces intelligently and efficiently, while also identifying solutions that effectively balance a number of competing constraints. Furthermore, the visual manifestation of XBIs also lends itself to quantification via a fitness function, which is a necessary element for a search-based technique. A fitness function computes a numeric assessment of the “closeness” of candidate solutions found during the search to the solution ultimately required.

A suitable fitness function may be constructed based on a measurement of the number of XBIs detected in a PUT, by using XBI detection techniques and the similarity of the layout of the PUT when rendered in the reference and test browsers, by comparing the size and positions of the bounding boxes of the HTML elements involved in each XBI identified.

The systems and methods described herein work by first detecting XBIs in a page and identifying a set of possible root causes for those XBIs. Then, the approach utilizes two phases of guided search to find the best repair. The first search determines a new value for each CSS property of each root cause that is most optimal with respect to the fitness function. This optimized property value is referred to as a candidate fix. The second search then seeks to find an optimal combination of candidate fixes identified in the first phase. This additional search is necessary since not all candidate fixes may be required, as the CSS properties involved may have duplicate or competing effects. For example, the CSS properties margin-top and padding-top may both be identified as root causes for an XBI, but can be used to achieve similar outcomes meaning that only one may actually need to be included in the repair. Conversely, other candidate fixes may be required to be used in combination with one another to fully resolve an XBI. For example, an HTML element may need to be adjusted for both its width and height. Furthermore, candidate fixes produced for one XBI may have knock-on effects on the results of candidate fixes for other XBIs, or even introduce additional and unwanted XBIs. By searching through different combinations of candidate fixes, the second search aims to produce a suitable subset—a repair—that resolves as many XBIs as possible for a page when applied together.

Algorithm 1 illustrates a top level algorithm of the approach of the systems and methods described herein. Three inputs are required: the page under test (PUT), the reference browser (R) and the test browser (T). The PUT is the page which exhibits XBIs and may be obtained via a URL that points to a location on the file system or network that provides access to all of the necessary HTML, CSS, Javascript, and media files for rendering the PUT. The reference browser (R) shows the correct (or intended) rendering of the PUT. The test browser (T) shows the rendering of the PUT with XBIs with respect to R. The output of the systems and methods described herein is a page, PUT′, a repaired version of the PUT.

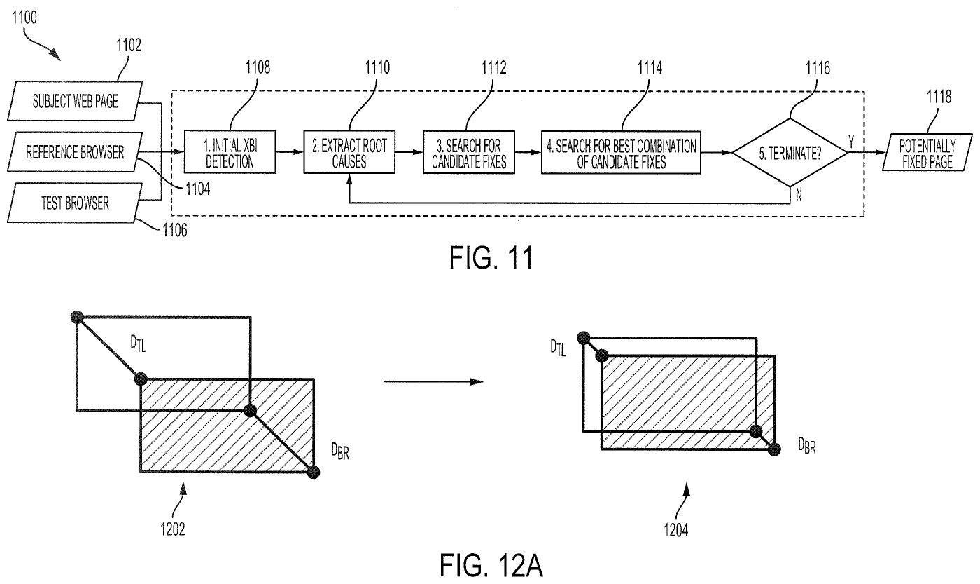

FIG. 11 illustrates a process performed by Algorithm 1. The process 1100 may be performed by a processor (e.g., processor 102) of a computing device (e.g., computing device 100). The process 1100 receives, as inputs, the subject web page (or PUT) 1102, the reference browser 1104, and the test browser 1106.

Step 1108 of the process 1100 (corresponding to lines 1-4 of Algorithm 1) involves obtaining the set of XBIs X when PUT is rendered in R and T. To identify XBIs, a software tool (e.g., the X-PERT tool), which is represented by the “getXBIs” function called on line 2, is used. X-PERT returns a set of identified XBIs, X, in which each XBI is represented by a tuple of the form [symbol] label, [symbol] e1, e2 [symbol] [symbol] , where e1 and e2 are the XPaths of the two HTML elements of the PUT that are rendered differently in T versus R, and label is a descriptor that denotes the original (correct) layout position of e1 that was violated in T. Again, the XPath is a reference for each HTML element in the DOM tree. For example, [symbol] top-align, e1, e2 [symbol] indicates that e1 is pinned to the top edge of e2 in R, but not in T.

Step 1110 of the process 1100 (corresponding to lines 6-16 of Algorithm 1) extracts the root causes relevant to each XBI. The key step in this step identifies CSS properties relevant to the XBI's label (shown as “getCSSProperties” at line 9). For example, for the top-align label, the CSS properties margin-top and top can alter the top alignment of an element with respect to another and would therefore be identified in this stage. This mapping holds true for all web applications without requiring developer intervention. Each relevant CSS property forms the basis of two root causes, one for e1, and one for e2. These are added to the running set rootCauses, with the values of the CSS properties extracted for each element (v1 and v2 respectively) extracted from the DOM of the PUT when it is rendered in T (lines 11 and 13).

Step 1112 of the process 1100 (corresponding to lines 17-22 of Algorithm 1) is the first phase search, which produces individual candidate fixes for each root cause. The fix is a new value for the CSS property that is optimized according to a fitness function, with the aim of producing a value that resolves, or is as close as possible to resolving the layout deviation. This optimization process occurs in the “searchForCandidateFix” procedure, which is described in detail herein.

Step 1114 of the process 1100 (corresponding to line 24 of Algorithm 1) is the second phase search, which searches for the best combination of candidate fixes. The algorithm makes a call to the “searchForBestRepair” procedure that takes the set of candidate fixes in order to find a subset, “repair,” representing the best overall repair. This is described in further detail herein.

Step 1116 of the process 1100 (corresponding to lines 25-36) determines whether the algorithm should terminate or proceed to another iteration of the loop and two-phase search. Initially, the fixes in the set repair are applied to a copy of PUT by adding test browser (T) specific CSS code to produce a modified version of the page PUT′ (line 26). The approach identifies the set of XBIs, X′ for PUT′, with another call to the “getXBIs” function (line 27).

Ideally, all of the XBIs in PUT will have been resolved by this point, and X′ will be empty. If this is the case, the algorithm returns the repaired page PUT′. If the set X′ is identical to the original set of XBIs X (originally determined on line 2), the algorithm has made no improvement in this iteration of the algorithm, and so the PUT′ is returned, having potentially only been partially fixed as a result of the algorithm rectifying a subset of XBIs in a previous iteration of the loop. If the number of XBIs has increased, the current repair introduces further layout deviations. In this situation, PUT is returned (which may reflect partial fixes from a previous iteration of the loop, if there were any). However, if the number of XBIs has been reduced, the current repair represents an improvement that may be improved further in another iteration of the algorithm.

Algorithm 1 Overall Algorithm

| Input: | PUT: Web page under test |
|---|---|
| | R: Reference Browser |
| | T: Test browser |
| Output: | PUT′: Modified PUT with repair applied |

| | |
|---|---|
| 1: | /* Stage 1 - Initial XBI Detection */ |
| 2: | X ← getXBIs(PUT, R, T) |
| 3: | DOM_{R} ← buildDOMTree(PUT, R) |
| 4: | DOM_{T} ← buildDOMTree(PUT, T) |
| 5: | while true do |

| | |
|---|---|
| 6: | /* Stage 2 - Extract root causes */ |
| 7: | rootCauses ← { } |
| 8: | for each [symbol] label, [symbol] e₁, e₂ [symbol] [symbol] ∈ X do |

| | |
|---|---|
| 9: | props ← getCSSProperties(label) |
| 10: | for each p ∈ props do |

| | |
|---|---|
| 11: | v₁ ← getValue(e₁,p, DOM_{T}) |
| 12. | rootCauses ← rootCauses ∪ [symbol] e₁, p, v_{1,} [symbol] |
| 13: | v₂ ← getValue(e₂,p, DOM_{T}) |
| 14: | rootCauses ← rootCauses ∪ [symbol] e₂, p, v_{2,} [symbol] |

| | |
|---|---|
| 15: | end for |

| | |
|---|---|
| 16: | end for |
| 17: | /* Stage 3 - Search for Candidate Fixes */ |
| 18: | candidateFixes ← { } |
| 19: | for each [symbol] e, p, v [symbol] ∈ rootCauses do |

| | |
|---|---|
| 20: | candidateFix ← searchForCandidateFix ( [symbol] e, p, v [symbol] , |
| | PUT, DOM_{R}, T) |
| 21: | candidateFixes ← candidateFixes ∪ candidateFix |

| | |
|---|---|
| 22: | end for |
| 23: | /* Stage 4 - Search for Best Combination of Candidate Fixes */ |
| 24: | repair ← searchForBestRepair(candidateFixes, PUT, R, T) |
| 25: | /* Stage 5 -Check Termination Criteria */ |
| 26: | PUT′ ← applyRepair(PUT, repair) |
| 27: | X′ ← getXBIs (PUT′, R, T) |
| 28: | if X′ = ø or X′ = X then |

| | |
|---|---|
| 29: | return PUT′s |

| | |
|---|---|
| 30: | else if \|X′\| > \|X\| then |

| | |
|---|---|
| 31: | return PUT |

| | |
|---|---|
| 32: | else |

| | |
|---|---|
| 33: | X ← X′ |
| 34: | PUT ← PUT′ |
| 35: | DOM_{T} ← buildDOMTree(PUT′, T) |

| | |
|---|---|
| 36: | end if |

| | |
|---|---|
| 37: | end while |

The first search phase (step 1112 of FIG. 11 and represented in Algorithm 1 as the procedure “searchForCandidateFix”) focuses on each potential root cause [symbol] e, p, v [symbol] in isolation of the other root causes, and attempts to find a new value v′ for the root cause that improves the similarity of the page when rendered in the reference browser R and the test browser T. Guidance to this new value is provided by a fitness function that quantitatively compares the relative layout discrepancies between e and the elements that surround it when PUT is rendered in R and T.

The inputs to the search for a candidate fix are the page under test, PUT, the test browser, T, the DOM tree from the reference browser, DOM_{R}, and the root cause tuple, [symbol] e, p, v [symbol] . The search attempts to find a new value, v′, for p in the root cause. The search process used to do this is based on the variable search component of the Alternating Variable Method (AVM), and specifically the use of “exploratory” and “pattern” moves to optimize variable values. The aim of exploratory moves is to probe values neighboring the current value of v to find one that improves fitness when evaluated with the fitness function. Exploratory moves involve adding small delta values (e.g., [−1,1]) to v and observing the impact on the fitness score. If the fitness is observed to be improved, pattern moves are made in the same “direction” as the exploratory move to accelerate further fitness improvements through step sizes that increase exponentially. If a pattern move fails to improve fitness, the method establishes a new direction from the current point in the search space through further exploratory moves. If exploratory moves fail to yield a new direction (i.e., a local optima had been found), this value is returned as the best candidate fix value. The fix tuple, [symbol] e, p, v, v′ [symbol] , is then returned to the main algorithm (line 20 of Algorithm 1).

Algorithm 2 Fitness Function for Candidate Fixes

| Input: | e: XPath of HTML element under analysis |
|---|---|
| | p: CSS property of HTML element, e |
| | \hat{v}: Value of CSS property, p |
| | PUT: Web page under test |
| | DOM_{R}: DOM tree of PUT rendered in R |
| | T: Test browser |
| Output: | fitness: Fitness value of the hypothesized fix |
| | <e, p, \hat{v}> |

| | |
|---|---|
| 1: | [symbol] ← apply Value(e, p, \hat{v}, PUT) |
| 2: | DOM_{T} ← buildDOMTree( [symbol] , T) |
| 3: | /* Component 1 - Difference in location of e with respect to R |
| | and T */ |
| 4: | [symbol] x₁^{t}, y₁^{t}, x₂^{t}, y₂^{t}, [symbol] ← getBoundingBox(DOM_{T}, e) |
| 5: | [symbol] x₁^{r}, y₁^{r}, x₂^{r}, y₂^{r}, [symbol] ← getBoundingBox(DOM_{R}, e) |
| 6: | D_{TL} ← \sqrt{(x₁^{t} − x₁^{r})² + (y₁^{t} − y₁^{r})²} |
| 7: | D_{BR} ← \sqrt{(x₂^{t} − x₂^{r})² + (y₂^{t} − y₂^{r})²} |
| 8: | Δpos ← D_{TL} + D_{BR} |
| 9: | /* Component 2 - Difference in size of e with respect to R and |
| | T */ |
| 10: | width_{R} ← x₂^{r} − x₁^{r} |
| 11: | width_{T} ← x₂^{t} − x₁^{t} |
| 12: | height_{R} ← y₂^{r} − y₁^{r} |
| 13: | height_{T} ← y₂^{t} − y₁^{t} |
| 14: | Δ_{size} ← \| width_{R} − width_{T} \| + \| height_{R} − height_{T} \| |
| 15: | /* Component 3 - Differences in locations of neighboring |
| | elements of e */ |
| 16: | neighbors_{T} ← getNeighbors(e, DOM_{T}, Nᵣ) |
| 17: | Δₙₚₒₛ ← 0 |
| 18: | for each n ∈ 0 neighbors_{T} do |

| | |
|---|---|
| 19: | n′← getMatchingElement(n, DOM_{R}) |
| 20: | [symbol] x₁^{t}, y₁^{t}, x₂^{t}, y₂^{t}, [symbol] ← getBoundingBox(DOM_{T}, n) |
| 21: | [symbol] x₁^{r}, y₁^{r}, x₂^{r}, y₂^{r}, [symbol] ← getBoundingBox(DOM_{R}, n′) |
| 22: | D_{TL} ← \sqrt{(x₁^{t} − x₁^{r})² + (y₁^{t} − y₁^{r})²} |
| 23: | D_{BR} ← \sqrt{(x₂^{t} − x₂^{r})² + (y₂^{t} − y₂^{r})²} |
| 24: | Δₚₒₛ ← D_{TL} + D_{BR} |
| 25: | Δₙₚₒₛ ← Δₙₚₒₛ + Δₚₒₛ |

| | |
|---|---|
| 26: | end for |
| 27: | /* Compute final fitness value */ |
| 28: | fitness ← (w₁ * Δₚₒₛ) + (w₂ * Δ_{size}) + (w₃ * Δₙₚₒₛ) |
| 29: | return fitness |

The fitness function for producing a candidate fix is shown by Algorithm 2. The goal of the fitness function is to quantify the relative layout deviation for PUT when rendered in R and T following the change to the value of a CSS property for an HTML element. Given the element e in the PUT, the fitness function considers three aspects of layout deviation between the two browsers: (1) the difference in the location of e; (2) the difference in the size of e; and (3) any differences in the location of e's neighbors.

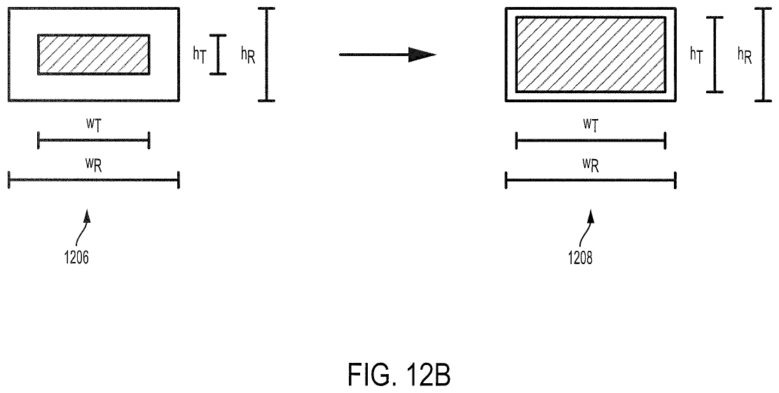

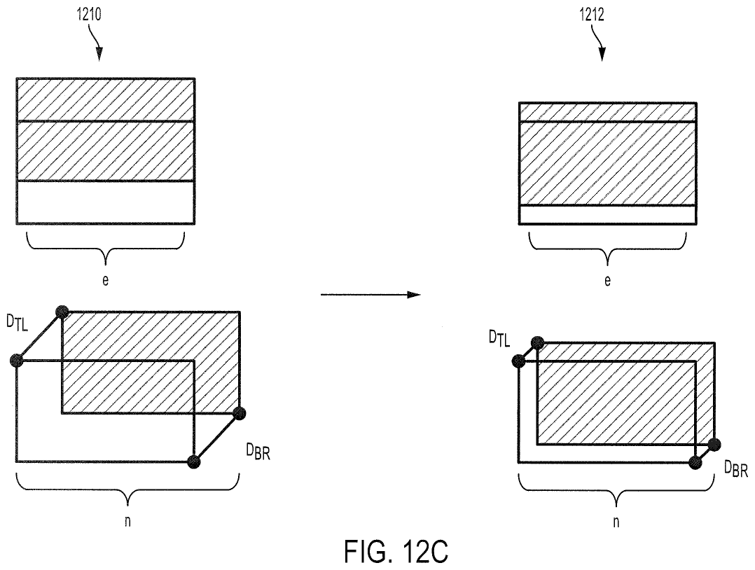

FIGS. 12A-12C show a diagrammatic representation of these aspects. Intuitively, all three aspects should be minimized as the evaluated fixes make progress toward resolving an XBI without introducing any new differences or introducing further XBIs for e's neighbors. The fitness function for an evaluated fix is the weighted sum of these three aspects.

The first aspect is the location difference of e between the two browsers. The location difference is computed by lines 3-8 of Algorithm 2, and assigned to the variable Δpos. The location of the element is associated with a bounding box obtained from the DOM tree of the page for each browser.

As shown in FIG. 12A, this value is calculated as the sum of the Euclidean distance between the top-left (TL) and bottom-right (BR) corners of the bounding box of e when it is rendered in R and T. The rectangles with the solid background correspond to the bounding boxes of elements rendered in R and the rectangles with hatch marks correspond to the bounding boxes of elements rendered in T. Formulaically, Δpos=D_{TL}+D_{BR}, where D_{TL} and D_{TR} are the Euclidean distances between the top left (TL) and the bottom right (BR) corners. The Δpos of the first layout comparison 1202 is greater than the Δpos of the second layout comparison 1204. As a smaller deviation from the reference browser to the test browser is desirable, a smaller Δpos is accordingly desirable.

The second aspect is the difference in size of e between the two browsers. The size difference is computed by lines 10-14 of Algorithm 2, and is assigned to the variable Δsize. The location of the element is associated with a bounding box obtained from the DOM tree of the page for each browser.

As shown in FIG. 12B, the value is calculated as the sum of the differences of e's width and height when rendered in R and T. The rectangles with the solid background correspond to the bounding boxes of elements rendered in R and the rectangles with hatch marks correspond to the bounding boxes of elements rendered in T. Formulaically, Δsize=|w_{R}−W_{T}|+|h_{R}−h_{T}|, where w_{R} and h_{R} are the respective width and height of e rendered in R, and w_{T} and h_{T} are the respective width and height of e rendered in T. The Δsize of the first layout comparison 1206 is greater than the Δsize of the second layout comparison 1208. As a smaller deviation from the reference browser to the test browser is desirable, a smaller Δsize is accordingly desirable.

The third aspect of the fitness function is the location difference of e's neighbors. This computation is performed on lines 16-26 of Algorithm 2, and is assigned to the variable Δnpos. The location of the element is associated with a bounding box obtained from the DOM tree of the page for each browser. The neighbors of e are the set of HTML elements that are within Nᵣ hops from e in PUT's DOM tree as rendered in T. For example, if Nᵣ=1, then the neighbors of e are its parents and children. If Nᵣ=2, then the neighbors are its parent, children, siblings, grandparent, and grandchildren. For each neighbor, the approach finds its corresponding element in the DOM tree of PUT rendered in R and calculates Δpos for each pair of elements. The final fitness value is then formed from the weighted sum of the three components Δpos, Δsize, and Δnpos (line 28).

As shown in FIG. 12C, Δnpos is the sum of the Euclidean distance between the top-left (TL) and bottom-right (BR) corners of the bounding box of n when e is rendered in R and T. The rectangles with the solid background correspond to the bounding boxes of elements rendered in R and the rectangles with hatch marks correspond to the bounding boxes of elements rendered in T. Formulaically, Δnpos=D_{TL}+D_{BR}, where D_{TL} and D_{TR} are the Euclidean distances between the top left (TL) and the bottom right (BR) corners of e's neighbor n, rendered in R and T. In the first layout comparison 1210, the difference in location of e, as shown by the difference in overlapping solid background and hatch marked background boxes of e, affects the location of e's neighbor n. Accordingly, in the first layout comparison 1210, n is offset by a first amount. However, in the second layout comparison 1212, the difference in location of e has been reduced, and accordingly, the difference in location of n is also reduced. That is, Δnpos decreases as e's boxes move closer, which causes n's boxes to also move closer.

The goal of the second search phase (represented by a call to “search-ForBestRepair” at line 24 of Algorithm 1) is to identify a subset of candidateFixes that together minimize the number of XBIs reported for the PUT. This step achieves two objectives.

Firstly, a fix involving one particular CSS property may only be capable of partially resolving an XBI and may need to be combined with another fix to fully address the XBI. Furthermore, the interaction of certain fixes may have emergent effects that result in further unwanted layout problems. For example, in a correct layout, a submit button element may appear to the right of a text box. However, in a particular layout to be fixed, the submit button may appear below the text box.

Candidate fixes may address the layout problem for each HTML element individually, attempting to move the text box down and to the left, and the button up and to the right. Taking these fixes together will result in the submit button appearing to the top right corner of the text box, rather than next to it. Identifying a selection of fixes (e.g., a candidate repair) that avoids these issues is the goal of this phase. To guide this search, the number of XBIs that appear in the PUT after the candidate repair has been applied is determined.

The search begins by evaluating a candidate repair with a single fix—the candidate fix that in the first search phase produced the largest fitness improvement. If this does not resolve all XBIs, the search continues by generating new candidate repairs in a biased random fashion. Candidate repairs are produced by iterating through the set of fixes. A fix is included in the repair with a probability impfix/impmax, where impfix is the improvement observed in the fitness score when the fix was evaluated in the first search phase divided by the maximum improvement observed over all of the fixes in candidateFixes. Each candidate repair is evaluated for fitness in terms of the number of resulting XBIs, with the best repair retained. A history of evaluated repairs is maintained, so that any repeat solutions produced by the biased random generation algorithm are not re-evaluated.

The random search terminates when (a) a candidate repair is found that fixes all XBIs, (b) a maximum threshold of candidate repairs to be tried has been reached, or (c) the algorithm has produced a sequence of candidate repairs with no improvement in fitness.

The systems and methods described herein for automatically repairing the identified issues must be performed by a computing device (e.g., computing device 100), as a human being could not perform the requisite computations with sufficient accuracy or precision. If a human being were to attempt to perform the methods and approaches described herein, the human being would be incapable of repairing the webpages with the efficiency, accuracy, and precision that the computing device is capable of.

Empirical experiments were conducted to assess the effectiveness and efficiency of the systems and methods described herein, with the aim of answering the following four research questions:

RQ1: How effective is the approach at reducing layout XBIs?

RQ2: What is the impact on the cross-browser consistency of the page when the suggested repairs are applied?

RQ3: How long does the approach take to find repairs?

RQ4: How similar in size are the approach-generated repair patches to the browser-specific code present in real-world websites?

The approach was implemented in a prototype tool in Java, named “XFix”. The Selenium WebDriver library was leveraged for making dynamic changes to web pages, such as applying candidate fix values. For identifying the set of layout XBIs, the latest publicly available version of the XBI detection tool, X-PERT was used. Minor changes were made to the publicly available version to fix bugs and add accessor methods for data structures. This modified version was used throughout the rest of the evaluation.

The fitness function parameters for the search of candidate fixes discussed herein were set as: Nr=2, and w1=1, w2=2, and w3=0.5 for the weights for Δpos, Δsize, and Δnpos respectively. The weights assigned prioritize Δsize, Δpos and Δnpos in that order. Size of an element was deemed as most important because of its likely impact on all three components, followed by location, which is likely to impact its neighbors. For the termination conditions (b) and (c) of the search for the best combination of candidate fixes, the maximum threshold value was set to 50 and the sequence value was set to 10.

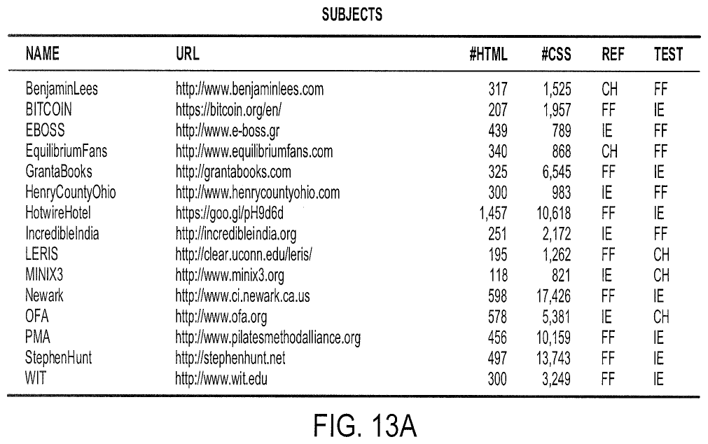

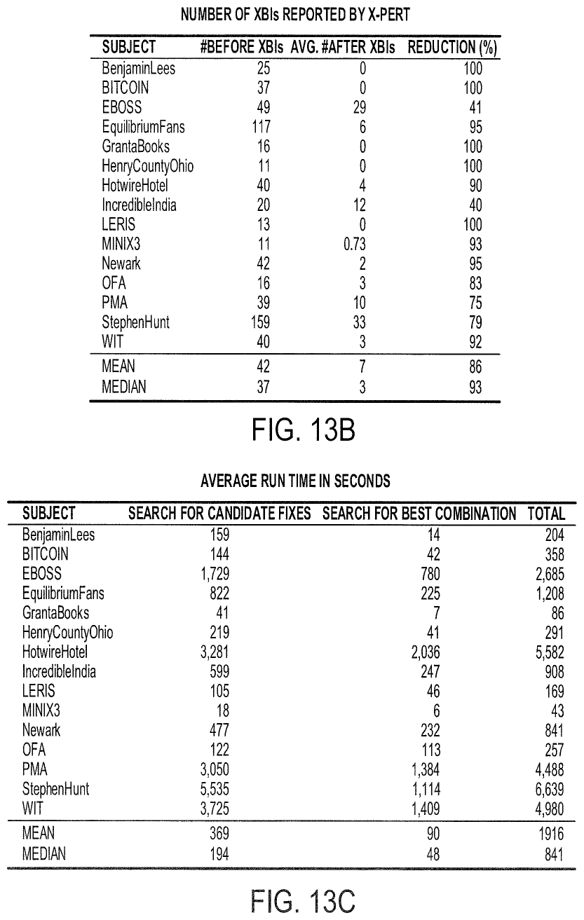

For the evaluation, 15 real-world subjects were used, as listed in FIG. 13A. The columns labeled “#HTML” and “#CSS” report the total number of HTML elements present in the DOM tree of a subject, and the total number of CSS properties defined for the HTML elements in the page respectively. These metrics of size give an estimate of a page's complexity in debugging and finding potential fixes for the observed XBIs. The “Ref” column indicates the reference browser in which the subject displays the correct layout. The “Test” column refers to the browser in which the subject shows a layout XBI. In these columns, “CH”, “FF”, and “IE” refer to the Chrome®, Firefox®, and Internet Explorer® browsers respectively.

The subjects were collected from three sources: (1) websites used in the evaluation of X-PERT, (2) prior interaction with websites exhibiting XBIs, and (3) the random URL generator, UROULETTE. The “GrantaBooks” subject came from the first source. The other subjects from X-PERT's evaluation could not be used because their GUI had been reskinned or the latest version of the IE browser now rendered the pages correctly. The “HotwireHotel” subject was chosen from the second source, and the remaining thirteen subjects were gathered from the third source.

The goal of the selection process was to select subjects that exhibited human perceptible layout XBIs. X-PERT was not used for an initial selection of subjects because it reported many subjects with XBIs that were difficult to observe. For selecting the subjects, the following process was used: (1) render the page, PUT, in the three browser types; (2) visually inspect the rendered PUT in the three browsers to find layout XBIs; (3) if layout XBIs were found in the PUT, select the browser showing a layout problem, such as overlapping, wrapping, or distortion of content, as the test browser, and one of the other two browsers showing the correct rendering as the reference browser; (4) try to manually fix the PUT by using the developer tools in browsers, such as Firebug for Firefox, and record the HTML elements to which the fix was applied; (5) run X-PERT on the PUT with the selected reference and test browsers; and (6) use the PUT as a subject, if the manually recorded fixed HTML elements were present in the set of elements reported by X-PERT. Steps 4-6 in the selection process were included to ensure that if X-PERT reported false negatives, they would not bias the evaluation results.

For the experiments, the latest stable versions of the browsers, Mozilla Firefox 46.0.1, Internet Explorer 11.0.33, and Google Chrome 51.0, were used. These browsers were selected for the evaluation as they represent the top three most widely used desktop browsers. The experiments were run on a 64-bit Windows 10 machine with 32 GB memory and a 3rd Generation Intel Core i7-3770 processor. The test monitor setup had a resolution of 1920×1080 and size of 23 inches. The subjects were rendered in the browsers with the browser viewport size set to the screen size.

Each subject was downloaded using the Scrapbook-X Firefox plugin and the wget utility, which download an HTML page along with all of the files (e.g., CSS, JavaScript, images, etc.) it needs to display. Portions of the JavaScript files and HTML code that made active connections with the server, such as Google Analytics, were commented out so that the subjects could be run locally in an online mode. The downloaded subjects were then hosted on a local Apache web server.

X-PERT was run on each of the subjects to collect the set of initial XBIs present in the page. XFix was then run 30 times on each of the subjects to mitigate non-determinism in the search, and measured the run time in seconds. After each run of XFix on a subject, X-PERT was run on the repaired subject and the remaining number of XBIs reported, if any, was recorded.

A human study was also conducted with the aim of judging XFix with respect to the human-perceptible XBIs, and to gauge the change in the cross-browser consistency of the repaired page. The study involved 11 participants consisting of Ph.D. and post-doctoral researchers whose field of study was Software Engineering. For the study, three screenshots of each subject page were first captured: (1) rendered in the reference browser, (2) rendered in the test browser before applying XFix's suggested repair, and (3) rendered in the test browser after applying the suggested fixes. These screenshots were embedded in HTML pages provided to the participants. The order in which the before (pre-XFix) and after (post-XFix) versions were presented to participants was varied to minimize the influence of learning on the results and referred to them in the study as version1 and version2 based on the order of their presentation.

Each participant received a link to an online questionnaire and a set of printouts of the renderings of the page. The participants were instructed to individually (i.e., without consultation) answer four questions per subject: The first question asked the users to compare the reference and version1 by opening them in different tabs of the same browser and circle the areas of observed visual differences on the corresponding printout. The second question asked the participants to rate the similarity of version1 and reference on a scale of 0-10, where 0 represents no similarity and 10 means identical. Note that the similarity rating includes the participants reaction to intrinsic browser differences as well since we did not ask them to exclude these. The third and fourth questions in the questionnaire were the same, but for version2.

For RQ1, X-PERT was used to determine the initial number of XBIs in a subject and the average number of XBIs remaining after each of the 30 runs of XFix. From these numbers the reduction of XBIs as a percentage was calculated.

For RQ2, the similarity rating results from the human study were classified into three categories for each subject: (1) improved: the after similarity rating was higher than that of the before version, (2) same: the after and before similarity ratings were exactly the same, and (3) decreased: the after similarity rating was lower than that of the before version.

For RQ3, the average total running times of XFix and for Stages 3 and 4 (the search phases of the algorithm) were collected.

For RQ4, the size, measured by the number of CSS properties, of browser specific code found in real-world websites was compared to that of the automatically generated repairs. Size was used for comparing similarity because CSS has a simple structure and does not contain any branching or looping constructs. The wget utility was used to download the homepages of 480 websites in the Alexa Top 500 Global Sites and analyzed their CSS to find the number of websites containing browser specific code. Twenty sites could not be downloaded as they pointed to URLs without UIs—for instance the googleadservices.com and twimg.com web services. To find whether a website has browser specific CSS, its CSS files were parsed using the CSS Parser tool and browser specific CSS selectors were searched based on well-known prefix declarations: -moz for Firefox, -ms for IE, and -webkit for Chrome. To calculate the size, the numbers of CSS properties declared in each browser specific selector were summed. To establish a comparable size metric for each subject web page used with XFix, the size of each subject's previously existing browser specific code for T, the test browser, was added to the average size of the repair generated for T.

FIG. 13B shows the results of RQ1. The results show that XFix reported an average 86% reduction in XBIs, with a median of 93%. This shows that XFix was effective in finding XBI fixes. Of the 15 subjects, XFix was able to resolve all of the reported XBIs for 33% of the subjects and was able to resolve more than 90% of the XBIs for 67% of the subjects.

The results were investigated to understand why the approach was not able to find suitable fixes for all of the XBIs. The dominant reason for this was that there were pixel-level differences between the HTML elements in the test and reference browsers that were reported as XBIs. In many cases, perfect matching at the pixel level was not feasible due to the complex interaction among the HTML elements and CSS properties of a web page.

Also, the different implementations of the layout engines of the browser meant that a few pixel-level differences were unavoidable. After examining these cases, it was determined that these differences would not be human perceptible.

To investigate this hypothesis, the user-marked printouts of the before and after versions from the human study were inspected. The areas of visual differences that represented inherent browser-level differences, such as font styling, font face, and native button appearance were filtered out, leaving only the areas corresponding to XBIs.

For all but one subject, the majority of participants had correctly identified the areas containing layout XBIs in the before version of the page but had not marked the corresponding areas again in the after version. This indicated that the after version did not show the layout XBIs after they had been resolved by XFix. Overall, this analysis showed an average 99% reduction in the human observable XBIs (median 100%), confirming the hypothesis that almost all of the remaining XBIs reported by X-PERT were not actually human observable.

RQ1: XFix reduced X-PERT-reported XBIs by a mean average of 86% (median 93%). Human-observable layout XBIs were reduced by a mean of 99% (median 100%).

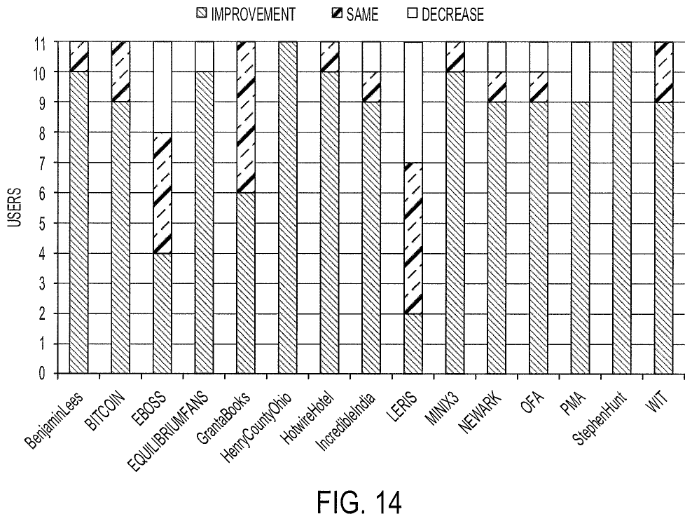

The impact of the approach on the cross-browser consistency of a subject was calculated based on the user ratings classifications: improved, same, or decreased. It was found that 78% of the user ratings reported an improved similarity of the after version, implying that the consistency of the subject pages had improved with our suggested fixes. 14% of the user ratings reported the consistency quality as same, and only 8% of the user ratings reported a decreased consistency. FIG. 14 shows the distribution of the participant ratings for each of the subjects. As can be seen, all of the subjects, except two (Eboss and Leris), show a majority agreement among the participants in giving the verdict of improved cross-browser consistency. The improved ratings without considering Eboss and Leris rise to 85%, with the ratings for same and decrease dropping to 10% and 4%, respectively.

The two outliers, Eboss and Leris, were investigated to understand the reason for high discordance among the participants. The reason for this disagreement was the significant number of inherent browser-level differences related to font styling and font face in the pages. Both of the subject pages are text intensive and contain specific fonts that were rendered very differently by the respective reference and test browsers. In fact, the browser-level differences were so dominant in these two subjects that some of the participants did not even mark the areas of layout XBIs in the before version. Since the approach does not suggest fixes for resolving inherent browser-level differences, the judgment of consistency was likely heavily influenced by these differences, thereby causing high disagreement among the users. To further quantify the impact of the intrinsic browser differences on participant ratings, intrinsic differences were controlled for. This controlled analysis showed a mean of 99% reduction in XBIs, a value consistent with the results in FIG. 13B.

RQ2: 78% of participant responses reported an improvement in the cross-browser consistency of pages fixed by XFix.

FIG. 13C shows the average time results over the 30 runs for each subject. These results show that the total analysis time of our approach ranged from 43 seconds to 110 minutes, with a median of 14 minutes. The table also reports time spent in the two search routines. The “searchForCandidateFix” procedure was found to be the most time consuming, taking up 67% of the total runtime, with “searchForBestRepair” occupying 32%. (The remaining 1% was spent in other parts of the overall algorithm, for example the setup stage.) The time for the two search techniques was dependent on the size of the page and the number of XBIs reported by X-PERT. Although the runtime is lengthy for some subjects, it can be further improved via parallelization.

RQ3: XFix had a median runtime of 14 minutes to resolve XBIs.

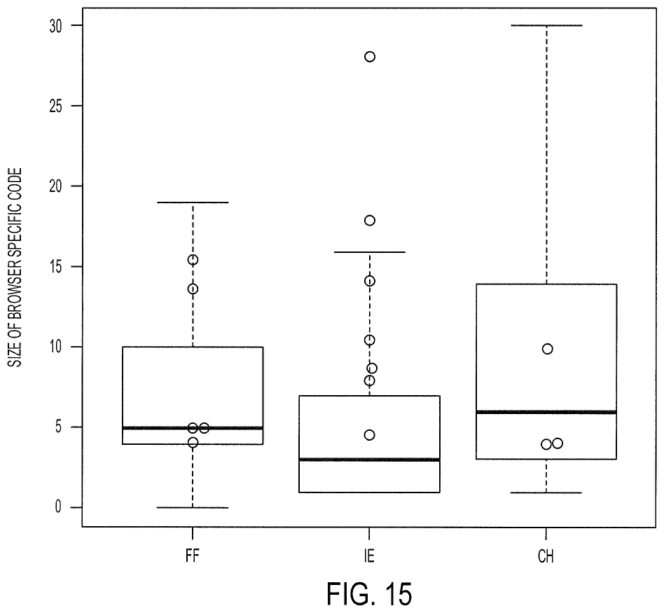

Analysis of the 480 Alexa websites revealed that browser specific code was present in almost 80% of the websites and therefore highly prevalent. This indicates that the patch structure of XFix's repairs, which employs browser specific CSS code blocks, follows a widely adopted practice of writing browser specific code. FIG. 15 shows a box plot for browser specific code size observed in the Alexa websites and XFix subjects. The boxes represent the distribution of browser specific code size for the Alexa websites for each browser (i.e., Firefox® (FF), Internet Explorer® (IE), and Chrome® (CH)), while the circles show the data points for XFix subjects. In each box, the horizontal line and the upper and lower edges show the median and the upper and lower quartiles for the distribution of browser specific code sizes, respectively. As the plot shows, the size of the browser specific code reported by Alexa websites and XFix subjects are in a comparable range, with both reporting an average size of 9 CSS properties across all three browsers (Alexa: FF=9, IE=7, CH=10 and XFix: FF=9, IE=13, CH=6).

RQ4: XFix generates repair patches that are comparable in size to browser speci€c code found in real-world websites.

The experiments described herein and their corresponding results demonstrate the effectiveness of the systems and methods described herein for automatically repairing XBIs of webpages in a technical, computationally-improved, and computationally-efficient manner. The experiments described herein also demonstrate that the technology being improved is technical, computer-dependent, and Internet-based technology.

Mobile-Friendly Issues:

Mobile devices have become one of the most common means of accessing the Internet. In fact, recent studies show that for a significant portion of web users, a mobile device is their primary means of accessing the Internet and interacting with other web-based services, such as online shopping, news, and communication.

Unfortunately, many websites are not designed to gracefully handle users who are accessing their pages through a non-traditional sized device, such as a smartphone or tablet. These problematic sites may exhibit a range of usability issues, such as unreadable text, cluttered navigation, or content that overflows the device's viewport and forces the user to pan and zoom the page in order to access content.

Such usability issues are collectively referred as mobile-friendly problems and lead to a frustrating and poor user experience. Despite the importance of mobile-friendly problems, they are highly prevalent in modern websites—in a recent study over 75% of users reported problems in accessing websites from their mobile devices. Over one third of users also said that they abandon mobile-unfriendly websites and find other websites that work better on mobile devices. This underscores the importance for developers in ensuring the mobile-friendliness of the web pages they design and maintain. Adding to this motivation is the fact that, as of April 2015, Google has incorporated mobile-friendliness as part of its ranking criteria when returning search results to mobile devices. This means that unless a website is deemed to be mobile friendly, it is less likely to be highly ranked in the results returned to users.

Making websites mobile-friendly is challenging even for a well-motivated developer. These challenges arise from the difficulties in detecting and repairing mobile-friendly problems. To detect these problems, developers must be able to verify a web page's appearance on many different types and sizes of mobile devices. Since the scale of testing required for this is generally quite large, developers often use mobile testing services, such as BrowserStack™ and SauceLabs™, to determine if there are problems in their sites. However, even with this information, it is difficult for developers to improve or repair their pages. The reason for this is that the appearance of web pages is controlled by complex interactions between the HTML elements and CSS style properties that define a web page. This means that to fix a mobile friendly problem, developers must typically adjust dozens of elements and properties while at the same time ensuring that these adjustments do not impact other parts of the page. For example, a seemingly simple solution, such as increasing the font size of text or the margins of clickable elements, can result in a distorted user interface that is unlikely to be acceptable to end users or developers.

Existing approaches are limited in helping developers to detect and repair mobile friendly problems. For example, the Mobile Friendly Test Tools produced by Google® and Bing®, only focus on the detection of mobile friendly problems in a web page. While these tools may provide hints or suggestions as to how to repair the pages, the task of performing the repair is still a manual effort. Developers may also use frameworks, such as Bootstrap™ and Foundation™, to help create pages that will be mobile friendly. However, the use of frameworks cannot guarantee the absence of mobile-friendly problems. Some commercial websites attempt to automate this process, but are generally targeted for hobbyist pages as they require the transformed website to use one of their preset templates. This leaves developers with a lack of automated support for repairing mobile friendly problems.

To address this problem, the systems and methods disclosed herein automatically generate CSS patches that can improve the mobile friendliness of a web page. To do this, the approach builds graph-based models of the layout of a web page. It then uses constraints encoded by these graphs to find patches that can improve mobile friendliness while minimizing layout disruption. To efficiently identify the best patch, the approach leverages unique aspects of the problem domain to quantify metrics related to layout distortion and parallelize the computation of the solution.

Widely used mobile testing tools provided by Google® and Bing® report mobile friendly problems in five areas:

1. Font sizing: Font sizes optimized for viewing a web page on a desktop are often too small to be legible on a mobile device, forcing users to zoom in to read the text, and then out again to navigate around the page.

2. Tap target spacing: “Tap targets” are elements on a web page, such as a hyperlinks, buttons, or input boxes, that a user can tap or touch to perform actions, such as navigate to another page or fill and submit a form. If tap targets are located close to each other on a mobile screen, it can become difficult for a user to physically select the desired element without hitting a neighboring element accidentally. Targets may also be too small, requiring users to zoom into the page in order to tap them on their device.

3. Content sizing: When a web page extends beyond the width of a device's viewport, the user is required to scroll horizontally or zoom out to access content. Horizontal scrolling is particularly considered problematic since users are typically used to scrolling vertically but not horizontally. This can lead to important content being missed by users. Therefore attention to content sizing is particularly important on mobile devices, where a smaller screen means that space is limited, and the browser may not be resizable to fit the page.

4. Viewport configuration: Using the “meta viewport” HTML tag allows browsers to scale web pages based on the size of a user's device. Web pages that do not specify or correctly use the tag may have content sizing issues, as the browser may simply scale or clip the content without adjusting for the layout of the page.

5. Flash usage: Flash content is not rendered by most mobile browsers. This makes content based on Flash, such as animations and navigation, inaccessible.

There are a number of ways in which a website can be adjusted to become more mobile friendly. A common early approach was to simply build an alternative mobile version of an existing desktop website. Such websites were typically hosted at a separate URL and delivered to a user when the web server detected the use of a mobile device. However, the cost and effort of building such a separate mobile website was high. To address this problem, commercial services, such as bMobilized™ and Mobify™, can automatically create a mobile website from a desktop version using a series of pre-designed templates.

A drawback of these templated websites, however, is that they fail to capture the distinct design details of the original desktop version, making them look identical to every other organization using the service. Broadly speaking, although having a separate mobile website could address mobile friendly concerns, it introduces a heavy maintenance debt on the organization in ensuring that the mobile website renders and behaves consistently and as reliably as its regular desktop version, thereby doubling the cost of an organization's online presence. Furthermore, having a separate mobile-only site would not help improve search-engine rankings of the organization's main website, since the two versions reside at different URLs.

To avoid developing and maintaining separate mobile and desktop versions of a website, an organization may employ responsive design techniques. This kind of design makes use of CSS media queries to dynamically adjust the layout of a page to the screen size on which it will be displayed. The advantage of this technique over mobile dedicated websites is that the URL of the website remains the same. However, converting an existing website into a fully responsive website is an extremely labor intensive task, and is better suited for websites that are being built from scratch. As such, repairing an existing website may be a more cost effective solution than completely redeveloping the site. Furthermore, although a responsive design is likely to allow for a good mobile user experience, it does not necessarily preclude the possibility of mobile friendly problems, since additional styles may be used or certain provided styles may be incorrectly overridden.

The systems and methods described herein address mobile friendly problems by adjusting specific CSS properties in the page and producing a repair patch. The repair patch uses CSS media queries to ensure that the modified CSS is only used for mobile viewing—that is, it does not affect the website when viewed on a desktop.

The systems and methods described herein automatically generate a patch that can be applied to the CSS of a web page to improve its mobile friendliness, and addresses the three specific problem types introduced above, namely font sizing, tap target spacing, and content sizing for the viewport—factors used by Google® to rate the mobile friendliness of a page.

There may appear to be a straightforward fix for these problems—simply increase the font size used in the page and the margins of the elements within it. The result, however, is one that would likely be unacceptable to an end-user: such changes tend to significantly disrupt the layout of a page and require the user to perform excessive panning and scrolling. The challenge in generating a successful repair, therefore, involves balancing two objectives—addressing a page's mobile friendliness problems, while also ensuring an aesthetically pleasing and usable layout.

The systems and methods described herein generate a solution that is as faithful as possible to the page's original layout. This involves fixing mobile friendliness problems while maintaining, where possible, the relative proportions and positioning of elements that are related to one another on the page (for example, links in the navigation bar, and the proportions of fonts for headings and body text in the main content pane).

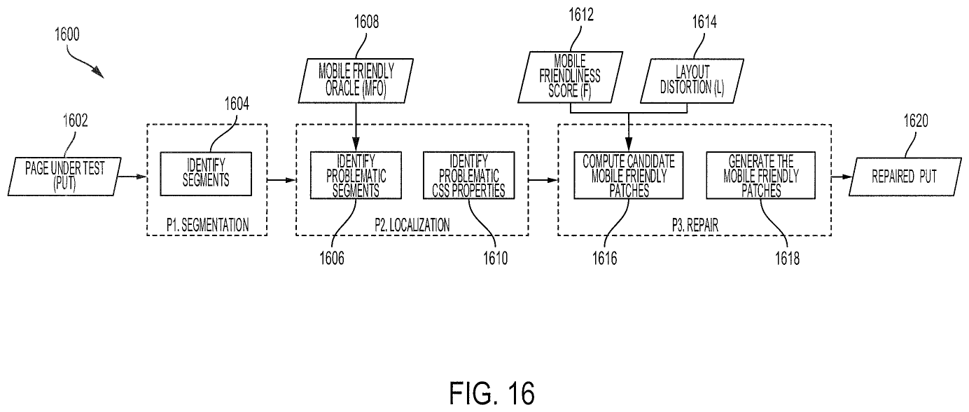

The approach for generating a CSS patch can be roughly broken down into three distinct phases, segmentation, localization, and repair. These are shown in FIG. 16. The process shown in FIG. 16 may be performed by a processor (e.g., processor 102) of a computing device (e.g., computing device 100). The input is the URL of a page under test (PUT) 1602. Typically, this would be a page that has been identified as failing a mobile friendly test (e.g., Google's or Bing's), but it may also be a page for which a developer would like to simply improve mobile friendliness. The segmentation phase identifies elements that form natural visual groupings on the page—referred to as segments. The localization phase then identifies the mobile friendly problems in the page, and relates these to the HTML elements and CSS properties in each segment. The last phase—repair—seeks to adjust the proportional sizing of elements within segments, along with the relative positions of each segment and the elements within them in order to generate a suitable patch.

The first phase analyzes the structure of the page to identify segments (step 1604). Segments are sets of HTML elements whose properties should be adjusted together to maintain the visual consistency of the repaired web page. An example of a segment is a series of text-based links in a menu bar where if the font size of any link in the segment is too small, then all of the links should be adjusted by the same amount to maintain the links' visual consistency.

Segments are used because once the optimal fix value for an element is identified, in order to maintain visual consistency, the same value would also need to be applied to closely related elements (i.e., those in the element's segment). Use of segments allows the many HTML elements to be treated as an equivalence class, which reduces the complexity of the patch generation process.

To identify the segments in a page, the Document Object Model (DOM) tree of the PUT is analyzed. Any method of traversing elements of a tree may be used to identify segments. An example automated clustering-based partitioning algorithm starts by assigning each leaf element of the DOM tree to its own segment. Then, to cluster the elements, the example algorithm iterates over the segments and uses a cost function to determine when it can merge adjacent segments. The cost function is based on the number of hops in the DOM tree between the lowest common ancestors of the two segments under consideration. If the number of hops is below a threshold based on the average depth of leaves in the DOM tree, then the example algorithm will cluster the adjacent segments.

The value of this threshold may be determined empirically. The example algorithm continues to iterate over the segments until no further merges are possible (i.e., the segment set has reached a fixed point). The output is a set of segments, Segs, where each segment contains a set of XPath IDs denoting the HTML elements that have been grouped together in the segment.

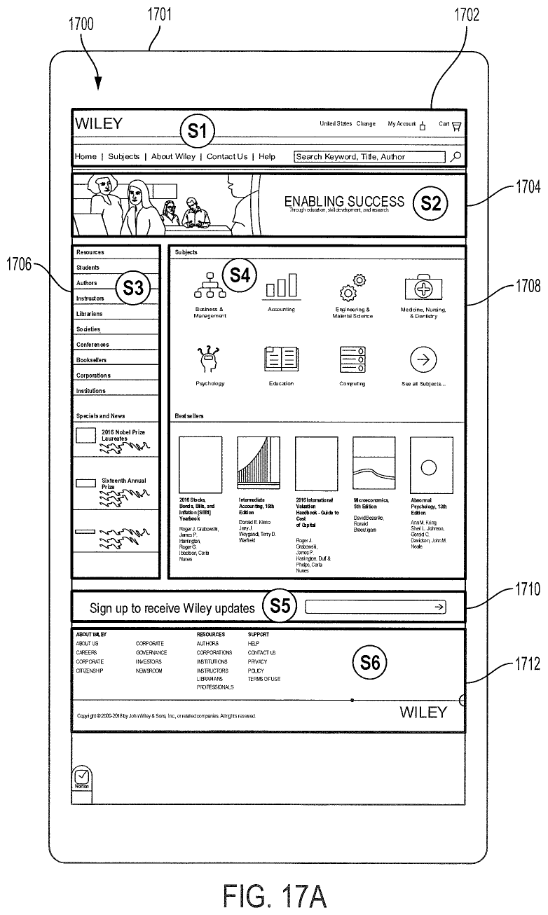

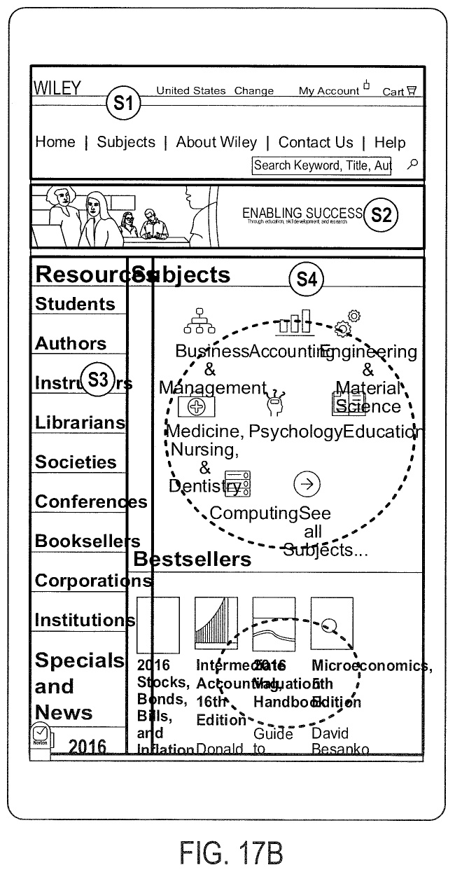

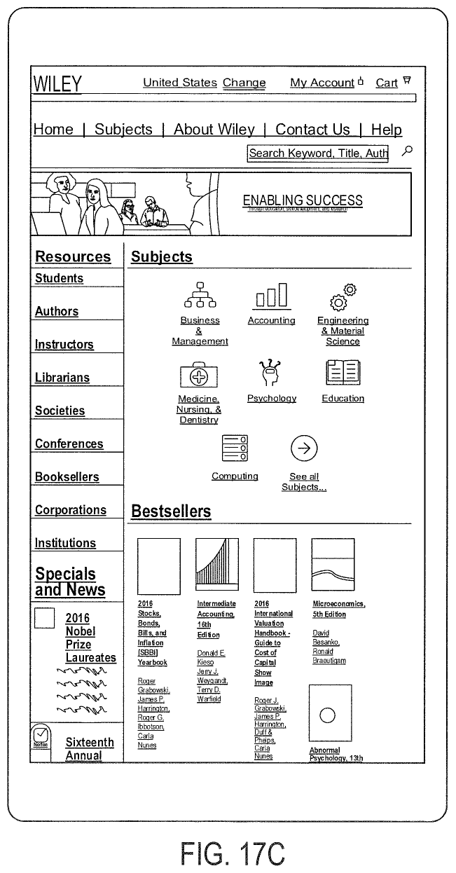

FIG. 17A illustrates segments identified for an example web page 1700 displayed on a mobile device 1701 (or computing device). The overlay rectangles 1702-1712 show the visible elements S1-S6 that were grouped together as segments. These include the header content 1702, a menu bar 1704, a left-aligned navigation menu 1706, the content pane 1708, and the page's footer 1710 and 1712.

The second phase identifies the parts of the PUT that must be targeted to address its mobile friendly problems. The second phase consists of two steps. In the first step, the approach analyzes the PUT to identify which segments contain mobile friendly problems (step 1606). Then, based on the structure and problem types identified for each segment, the second step identifies the CSS properties that will most likely need to be adjusted to resolve each problem (step 1610). The output of the localization phase is a mapping of the potentially problematic segments to these properties.

In the first step of the localization phase (step 1606), the approach identifies mobile friendly problem types in the PUT and the subset of segments that will likely need to be adjusted to address them. Mobile friendly problems in the PUT may be detected using a detection function, such as a Mobile Friendly Oracle (MFO) 1608. An MFO 1608 takes a web page as input and returns a list of mobile friendly problem types it contains. The MFO 1608 may identify the presence of mobile friendly problems but may not be capable of identifying the faulty HTML elements and CSS properties responsible for the observed problems.

In some embodiments, the Google Mobile-Friendly Test Tool (GMFT) may be used as the MFO 1608. However, any detector or testing tool may also be used as the MFO 1608. The basic requirement for the MFO 1608 is that it can accurately report whether there are any types of mobile friendly problems present in the page. In some embodiments, the MFO 1608 is also capable of detailing what types of problems are present, along with a mapping of each problem to the corresponding HTML elements. However, these are not strict requirements: the systems and methods described herein are capable of correctly operating with the assumption that all segments have all problem types. However, this over-approximation may increase the amount of time needed to compute the best solution in the second phase.

Given a PUT, the GMFT returns, for each problem type it detects, a reference to the HTML elements that contain that problem. However, the list of HTML elements it supplies is, many times, incomplete. Therefore, given a reported problem type, the systems and methods described herein apply a conservative filtering to the segments to identify which ones may be problematic with respect to that problem type. For example, if the GMFT reports that there is a problem with font sizing in the PUT, then systems and methods described herein identify any segment that contains a visible text element as potentially problematic. As mentioned herein, this over-approximation may increase the time needed to compute the best solution, but does not introduce unsoundness into the approach.

The output of this step is a set of tuples of the form [symbol] s,T [symbol] where s ∈Segs is a potentially problematic segment and T is the set of problem types associated with s (i.e., in the domain of {tap_targets, font_size, content_size}). Referring back to the example in FIG. 17A, GMFT identified left-aligned navigation menu 1706 as having two problem types, the tap targets were too close and the font size was too small, so the approach would generate a tuple for left-aligned navigation menu 1706 where T includes these two problem types.

After identifying the subset of problematic segments, the CSS properties that may need to be adjusted in each segment to make the page mobile friendly are identified (step 1610). In many situations, each of a segment's identified problem types generally map to a set of CSS properties within the segment. However, this step is complicated by the fact that HTML elements may not explicitly define a CSS property (e.g., they may inherit a style from a parent element) and that the approach adjusts CSS properties at the segment level instead of the individual element level.

To address these issues, a Property Dependence Graph (PDG) is used. For a given segment and problem type, the PDG models the relevant style relationships among its HTML elements based on CSS inheritance and style dependencies. Formally, a PDG is defined as a directed graph of the form [symbol] E, R, M [symbol] . Here e ∈ E is a node in the graph that corresponds to an HTML element in the PUT that has an explicitly defined CSS property, p ∈ P, where P is the set of CSS properties relevant for a problem type (e.g., font-size for font sizing problems, margin for tap target issues, etc.). R ⊆ E×Eisaset of directed edges, such that for each pair of elements [symbol] e1, e2 [symbol] ∈ R, there exists a dependency relationship between e1 and e2. M is a function M:R→2^{C} that maps each edge to a set of tuples of the form C: [symbol] p,φ [symbol] , where p ∈ P and φ is a ratio between the values of p for e1 and e2. This function is used in the repair phase to ensure that style changes made to a segment remain consistent across pairs of elements in a dependency relationship.

A variant of PDG is defined for each of the three problem types: the Font PDG (FPDG), the Content Size PDG (CPDG), and the Tap Target PDG (TPDG). Each of these three graphs has a specific set of relevant CSS properties (P), a dependency relationship, and a mapping function (M). While the formal definition of the FPDG is the only one presented, the other two graphs are defined in a similar manner.

The FPDG is constructed for any segment for which a font sizing problem type has been identified. For this problem type, the most relevant CSS property is clearly font-size, but the line-height, width, and height properties of certain elements may also need to be adjusted if font sizes are changed. Therefore P={font-size, line-height, width, height}. A dependency relationship exists between any e1, e2 ∈ E, if and only if e1 is an ancestor of e2 in the DOM tree and e2 has an explicitly defined CSS property, p ∈ P, i.e., the value of the property is not inherited from e1. The general intuition of using this dependency relationship is that only nodes that explicitly define a relevant property may need to be adjusted and the remainder of the nodes in between e1, e2 will simply inherit the style from e1. The ratio, φ, associated with each edge is the value of p defined for e1 divided by the value of p defined for e2.

In an example situation, two HTML elements may be present in left-aligned navigation menu 1706 of FIG. 17A. The first, e1, is a [symbol] div [symbol] tag wrapping all of the elements in left-aligned navigation menu 1706 with font-size=13 px and the second, e2, is the [symbol] h2 [symbol] element containing the text “Resources” with font-size=18 px. A dependency relationship exists from e1 to e2 with p as font-size and the ratio φ=0.72.

The output of this final step is the set, I, of tuples where each tuple is of the form [symbol] s, g, a [symbol] where s identifies the segment to which the tuple corresponds, g identifies a corresponding PDG, and a is an adjustment factor for the PDG that is initially set to 1. The adjustment factor is used in the repair phase and serves as a multiplier to the ratios defined for the edges of each PDG. A tuple is added to I for each problem type that was identified as applicable to a segment. Referring back to the example in FIG. 17A, the approach generates two tuples for left-aligned navigation menu 1706, one containing an FPDG and the other containing an TPDG.

A repair for the PUT is computed in the repair phase. The best repair balances two objectives. The first objective is to identify the set of changes—a patch—that will most improve the PUT's mobile friendliness. The second objective is to identify the set of changes that does not significantly change the layout of the PUT.

Both of the aforementioned objectives—mobile friendliness and layout distortion—can be quantified. For the first objective, it is typical for mobile friendly test tools to assign a numeric score to a page, where this score represents the page's mobile friendliness. For example, the Google PageSpeed Insights Tool (PSIT) assigns pages a score in the range of 0 to 100, with 100 being a perfectly mobile friendly page.

By treating this score as a function (F) 1612, that operates on a page, it is possible to establish an ordering of solutions and use that ordering to identify a best solution among a group of solutions. The second objective can also be quantified as a function (L) 1614, that compares the amount of change between the layout of a page containing a candidate patch versus the layout of the original page. The amount of change in a layout can be determined by building models that express the relative visual positioning among and within the segments of a page. These models are referred to as the Segment Model (SM) and Intra-Segment Model (ISM), respectively. Given these two models, the approach uses graph comparison techniques to quantify the difference between the models for the original page and a page with an applied candidate solution.

Formally, a Segment Model (SM) is defined as a directed complete graph where the nodes are the segments identified in the first phase and the edge labels represent layout relationships between segments. To determine the edge labels, the approach first computes the Minimum Bounding Rectangles (MBRs) of each segment. This is done by finding the maximum and minimum X and Y coordinates of all of the elements included in the segment, which can be found by querying the DOM of the page. Based on the coordinates of each pair of MBRs, the approach determines which of the following relationships apply: (1) intersection, (2) containment, or (3) directional (i.e., above, below, left, right). Each edge in an SM is labeled in this manner. Referring to FIG. 17A, one of the relationships identified would be that header content 1702 is above left-aligned navigation menu 1706 and the content pane 1708. An ISM is the same, but is built for each segment and the nodes are the HTML elements within the segment.

To quantify the layout differences between the original page and a transformed page to which a candidate patch has been applied, the approach computes two metrics. The first metric is at the segment level. The approach sums the size of the symmetric difference between each edge's labels in the SM of the original page and the SM of the transformed page. Recall that both models are complete graphs, so a counterpart for each edge exists in the other model.

To illustrate, consider the examples shown in FIGS. 17A and 17B. The change to the page has caused two segments (the left-aligned navigation menu 1706 and the content pane 1708) to overlap. This change in the relationship between the two segments would be counted as a difference between the two SMs and increase the amount of layout difference. The second metric is similar to the first but compares the ISM for each segment in the original and transformed page. The one difference in the computation of the metric is that the symmetric difference is only computed for the intersection relationship. The intuition behind this difference in counting is that movement of elements within a segment, except for intersection, is considered to be an acceptable change to accommodate the goal of increasing mobile friendliness. Referring back to the example shown in FIG. 17B, nine intra-segment intersections are counted among the elements in the content pane 1708 segment, as shown by dashed red ovals. The difference sums calculated at the segment and intra-segment level are returned as the amount of layout difference.

To identify the best CSS patch, the approach determines new values for the potentially problematic properties, identified in the first phase, that make the PUT mobile friendly while also maintaining its layout (step 1616).

That is, given I, the approach identifies a set of new values for each of the adjustment factors (a) in each tuple of I so that the value of F is 100 (i.e., the maximum mobile friendliness score) and the value of L is zero (i.e., there are no layout differences).

A direct computation of this solution faces two challenges. The first of these challenges is that an optimal solution that satisfies both of the above conditions may not exist. This can happen due to constraints in the layout of the PUT. The second challenge is that, even if such a solution were to exist, it exists in a solution space that grows exponentially based on the number of elements and properties that must be considered. Since many of the CSS properties have a large range of potential values, a direct computation of the solution would be too expensive to be practical. Therefore, an approximation algorithm is used to identify a repair. The approach finds a set of values that minimizes the layout score while maximizing the mobile friendliness score.

The design of the approximation algorithm takes into account several unique aspects of the problem domain to generate a high quality patch in a reasonable amount of time. The first of these aspects is that good or optimal solutions typically involve a large number of small changes to many segments. This motivates targeting a solution space comprised of candidate solutions that differ from the original page in many places, but by only small amounts. The second of these aspects is that computing the values of the L and F functions is expensive. The reason for this is that F requires accessing an API on the web and L requires rendering the page and computing layout information for the two versions of the PUT. This motivates avoiding algorithms that require sequential processing of L and F (e.g., simulated annealing or genetic algorithms).

To incorporate these insights, the approximation algorithm first generates a set of size n of candidate patches. To generate each candidate patch, the approach creates a copy of I, called I′, then iterates over each tuple in I′ and with probability x, randomly perturbs the value of the adjustment factor (a) using a process described in more detail herein. Then, I′ is converted into a patch, R, and added to the set of candidate patches. This process is repeated until the approach has generated n candidate patches. The approach then computes, in parallel, the values of F and L for a version of the PUT with an applied candidate patch. In an example embodiment, Amazon Web Services (AWS) is used to parallelize this computation.

The objective score for the candidate patch is then computed as a weighted sum of F and L. The candidate patch with the maximum score, i.e., with the highest value of F and the lowest value of L, is selected as the final solution, Rₘₐₓ. FIG. 17C shows Rₘₐₓ applied to the example page.

The approach perturbs adjustment factors in such a way as to take advantage of the insight that the optimal solutions differ from the original page in many places but by only small amounts. To represent this insight, the perturbation is based on a Gaussian distribution around the original value in a property. Through experimentation, it was found that having the mean (μ) and standard deviation (σ) values used for the Gaussian distribution vary based on the specific mobile friendly problem type being addressed was effective. For each problem type, the goal was to identify a μ and a that provided a large enough range to allow sufficient diversity in the generation of candidate patches. For identifying μ values, it was determined through experimentation that μ set at the values suggested by the GMFT was not effective in generating candidate patches that could improve the mobile friendliness of the PUT.

Therefore, an amendment factor is added to the values suggested by the GMFT to allow the approach to select a value considered mobile friendly with a high probability. The specific amendment factors found as being the most effective were: +14 for font size, −20 for content sizing, and 0 for tap target sizing problems. For example, if the GMFT suggested value for font size problems was 16 px, μ was set at 30 px. For each problem type, a σ value was identified. The specific values determined to be most effective were: σ=16 for content size problems, σ=5 for font size problems, and σ=2 for tap target spacing problems.

Given a set I, the approach generates a repair patch, R, and modifies the PUT so that R will be applied at runtime (step 1618). The general form of R is a set of CSS style declarations that apply to the HTML elements of each segment in I. To generate R, the approach iterates over all tuples in I. For each tuple, the approach iterates over each node of its PDG, starting with the root node, and computes a new value that will be assigned to the CSS property represented by the node. The new value for a node is computed by multiplying the new value assigned to its predecessor by the ratio, σ, defined on the edge with the predecessor. Once new property values have been computed for all nodes in the PDG, the approach generates a set of fixes, where each fix is represented as a tuple [symbol] i, p, v [symbol] , where i is the XPath for each node in the PDG that had a property change, p is the changed CSS property, and v is the newly computed value. These tuples are made into CSS style declarations by converting i into a CSS selector and then adding the declarations of p and v within the selector. All of the generated CSS style declarations are then wrapped in a CSS media query that will cause it to be loaded when accessed by a mobile device. The size range specified in the patch's media query is applicable to a wide range of mobile devices. However, to allow developers to generate patches for specific device sizes, configurable size parameters are provided in the media query. Finally, the repaired PUT 1620 is output.

Referring back to the example, the ratio (σ) between e1 ( [symbol] div [symbol] containing all elements in left-aligned navigation menu 1706) and e2 ( [symbol] h2 [symbol] containing text “Resources”) is 0.72. Consider a tuple [symbol] left-aligned navigation menu 1706 segment, font-size, 2 [symbol] in I. Thus, a value v of 26 px is calculated for the predecessor node e1 based on the adjustment factor 2. Accordingly v=26 px*1/0.72=36 px is calculated for e2. Thus, the approach generates two fix tuples: [symbol] div, font-size, 26 px [symbol] and [symbol] h2, font-size, 36 px [symbol] .

The systems and methods described herein for automatically repairing the identified issues must be performed by a computing device (e.g., computing device 100), as a human being could not perform the requisite computations with sufficient accuracy or precision. If a human being were to attempt to perform the methods and approaches described herein, the human being would be incapable of repairing the webpages with the efficiency, accuracy, and precision that the computing device is capable of.

To evaluate the approach, experiments were designed to determine its effectiveness, running time, and the visual appeal of its solutions. The specific research questions considered were:

RQ1: How effective is the approach in repairing mobile friendly problems in web pages?

RQ2: How long does it take for the approach to generate patches for the mobile friendly problems in web pages?

RQ3: How does the approach impact the visual appeal of web pages after applying the suggested CSS repair patches?

The approach was implemented in Java as a prototype tool named MFix. For identifying the mobile friendly problems in a web page, the Google Mobile-Friendly Test Tool (GMFT) and Google PageSpeed Insights Tool (PSIT) APIs were used. The PSIT was also used for obtaining the mobile friendliness score (labeled as “usability” in the PSIT report). For identifying segments in a web page and building the SM and ISM, the DOM tree was first built by rendering the page in an emulated mobile Chrome browser v60.0 and rendering information, such as element MBRs and XPath, was extracted using Javascript and SeleniumWebDriver. The segmentation threshold value determined by the average depth of leaves in a DOM tree was capped at four to avoid the situation where all of the visible elements in a page were wrapped in one large segment. This constant value was determined empirically, and was implemented as a configurable parameter inMFix. jStyleParser was used for identifying explicitly defined CSS properties for HTML elements in a page for building the PDG. The evaluation of candidate solutions was parallelized using a cloud of 100 Amazon EC2 t2.xlarge instances pre-installed with Ubuntu 16.04.

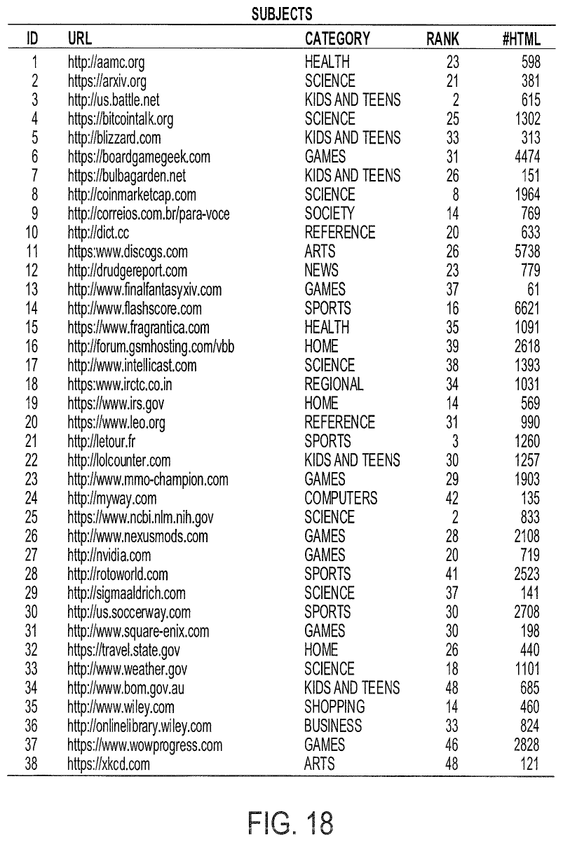

For the experiments 38 real-world subjects collected from the top 50 most visited websites across all seventeen categories tracked by Alexa were used. The subjects are listed in FIG. 18. The columns “Category” and “Rank” refer to the source Alexa category and rank of the subject within that category, respectively. The column “#HTML” refers to the total number of HTML elements in a subject, which was counted by parsing the subject's DOM for node type “element”.

This value gives an approximation for the size and complexity of the subject. Alexa was used as the source of the subjects as the websites represent popular widely used sites and a mix of different layouts. From the 651 unique URLs that were identified across the 17 categories, the websites that passed the GMFT or had adult content were excluded. Each of the remaining 38 subjects was downloaded using the Scrapbook-X Firefox plugin, which downloads an HTML page and its supporting files, such as images, CSS, and Javascript. The portions of the subject pages that made active internet connections, such as for advertisements, were removed to enable running of the subjects in an offline mode.

Experiment One

To address RQ1 and RQ2, MFix was run ten times on each of the 38 subjects to mitigate the non-determinism inherent in the approximation algorithm used to find a repair solution. For RQ1, two metrics were considered to gauge the effectiveness of the approach.

For the first metric, the GMFT was used to measure how many of the subjects were considered mobile friendly after the patch was applied. For the second metric, the before and after scores for mobile friendliness and layout distortion for each subject were compared. For comparing mobile friendliness score, for each subject over the ten runs, the repair that represented a median score was selected. For layout distortion, for each subject over the ten runs, the best and worst repair, in terms of layout distortion, that passed the mobile friendly test was selected. Essentially, for each subject, these were the two patched pages that passed the mobile friendly test and had the lowest (best) and highest (worst) amount of distortion. For the subjects that did not pass the mobile friendly test, the patched pages with the highest mobile friendly scores were considered to be the “passing” pages.

For RQ2, the average total running time of MFix for each of the ten runs for each of the subjects was measured, and the time spent in the different stages of the approach was also measured.

The results for effectiveness (RQ1) were that 95% (36 out of 38) of the subjects passed the GMFT after applying MFix's suggested CSS repair patch. This shows that the patches generated by MFix were effective in making the pages pass the mobile friendly test.

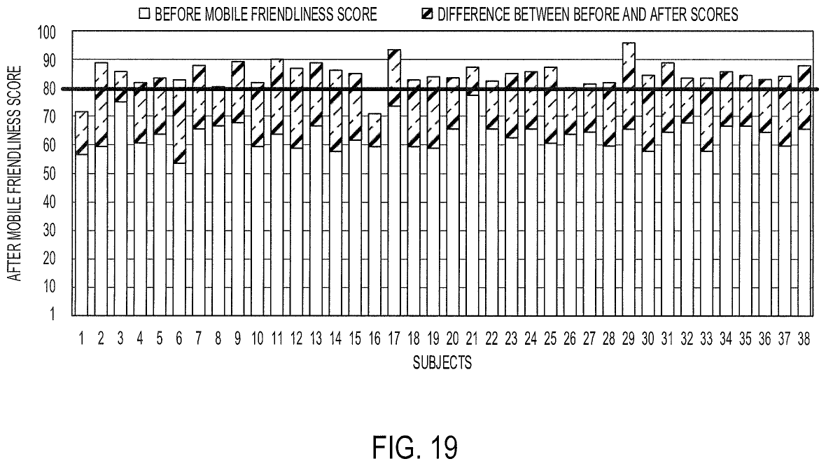

FIG. 19 shows the results of comparing the before and after median mobile friendliness scores for each subject. For each subject, the dark gray portion shows the score reported by the PSIT for the patched page and the light gray portion shows the score for the original version. The black horizontal line drawn at 80 indicates the value above which the GMFT considers a page to have passed the test and to be mobile friendly. On average, MFix improved the mobile friendliness score of a subject by 33% Overall, these results show that the approach was able to consistently improve a subject's mobile friendliness score.

The layout distortion score for the best and worst repairs of each subject were also compared. On average, the best repair had a layout distortion score 55% lower than the worst repair. These results show that the approach was effective in identifying patches that could reduce the amount of distortion in a solution that was able to pass the mobile friendly test. (For RQ3, it was examined, via a user study, if this reduction in distortion translates into a more attractive page.)

The results to understand why two subjects did not pass the GMFT was investigated. The patched version of the first subject, gsmhosting, contained a content sizing problem. The original version of the page did not contain this problem, which indicates that the increased font size introduced by the patch caused content in this page to overflow the viewport width. For the second subject, aamc, MFix was not able to fully resolve its content sizing problem as the required value was extremely large compared to the range explored by the Gaussian perturbation of the adjustment factor.

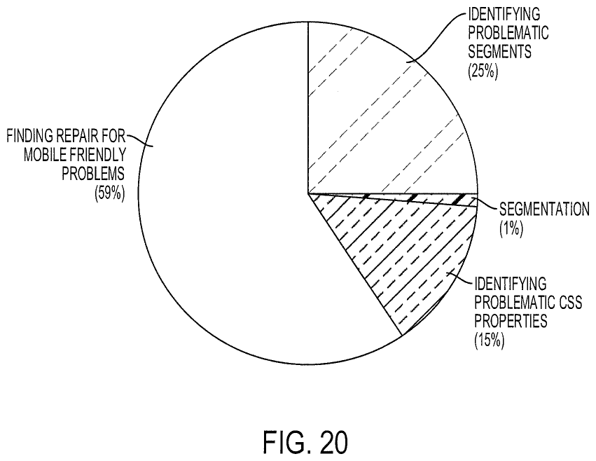

The total running time (RQ2) required by the approach for the different subjects ranged from 2 minutes to 10 minutes, averaging a little less than 5 minutes. As of August 2017, an Amazon EC2 t2.xlarge instance was priced at $0.188 per hour. Thus, with an average time of 5 minutes the cost of running MFix on 100 instances was $1.50 per subject. FIG. 20 shows a breakdown of the average time for the different stages of the approach. As can be seen from the chart, finding the repair for the mobile friendly problems (phase 3) was the most time consuming, taking up almost 60% of the total time. A major portion of this time was spent in evaluating the candidate solutions by invoking the PSIT API. The remainder of the time was spent in calculating layout distortion, which is dependent on the size of the page. The overhead caused by network delay in communicating with the Amazon cloud instances was negligible.

For the API invocation, a random wait time of 30 to 60 seconds between consecutive calls was implemented to avoid retrieving stale or cached results. Identifying problematic segments was the next most time consuming step as it required invoking the GMFT API.

Experiment Two

To address RQ3, a user-based survey was conducted to evaluate the aesthetics and visual appeal of the repaired page. The main intent of the study was to evaluate the effectiveness of the layout distortion metric, L (Section 3.3), in minimizing layout disruptions and producing attractive pages. The general format of the survey was to ask participants to compare the original and repaired versions of a subset of the subjects. To make the survey length manageable, the 38 subjects were divided into six different surveys, each with six or seven subjects. For each subject, the survey presented, in random order, a screenshot of the original and repaired pages when displayed in a frame of the mobile device. The screenshots were obtained from the output of the GMFT. An example of one such screenshot is shown in FIG. 17C. Each human subject was asked to (1) select which of the two versions (original or repaired) they would prefer to use on their mobile device; (2) rate the readability of each version of the page on a scale of 1-10, where 1 means low and 10 means high; and (3) rate the attractiveness of the page on a scale of 1-10, where 1 means low and 10 means high. There were two variants of the survey, one that used the best repair as the screenshot of the repaired page and the other one that used the worst repair as the screenshot of the repaired page. Here, the best and worst repairs were as defined in Experiment One.

Amazon Mechanical Turk (AMT) service was used to conduct the surveys. AMT allows users (requesters) to anonymously post jobs which it then matches them to anonymous users (workers) who are willing to complete those tasks to earn money. To avoid workers who had a track record of haphazardly completing tasks, only workers who had high approval ratings for their previously completed tasks (over 95%) and had completed more than 5,000 approved tasks were allowed to complete the survey. In general, this is considered a fairly selective criteria for participant selection on AMT. For each survey, there were 20 anonymous participants, for a total of 240 completed surveys across both variants of the survey. Each participant was paid $0.65 for completing a survey.

Based on the analysis of the results of the first variant of the survey, the users preferred to use the repaired version in 26 out of 38 subjects, three subjects received equal preference for the original and repaired versions, and only nine subjects received a preference for using the original version. Interestingly, users preferred to use the repaired version even for the two subjects that did not pass the GMFT. For readability, all but four subjects were rated as having an improved readability over the original versions. On average, the readability rating of the repaired pages showed a 17% improvement over original versions (original=5.97, repaired=6.98). This result was also confirmed as statistically significant using the Wilcoxon signed-rank test with a p-value=1.53×10−14<0.05. Using the effect size metric based on Vargha-Delaney A measure, readability of the repaired version was observed to be 62% of the time better than the original version. With regards to attractiveness, no statistical significance was observed, implying that MFix did not deteriorate the aesthetics of the pages in the process of automatically repairing the reported mobile friendly problems. In fact, overall, the repaired versions were rated slightly higher than original versions for attractiveness (avg. original=6.50, avg. repaired=6.67 and median original=6.02, median repaired=7.12).

The nine subjects where the repaired version was not preferred by the participants were investigated. Based on the analysis, there are two dominant reasons that applied to all of the nine subjects. First, these subjects all had a fixed sized layout, meaning that the section and container elements in the pages were assigned absolute size and location values. This caused a cascading effect with any change introduced in the page, such as increasing font sizes or decreasing width to fit the viewport. The second reason was linked to the first as the pages were text intensive, thereby requiring MFix to increase font sizes.

Overall, these results indicate that MFix was very effective in generating repaired pages that (1) users preferred over the original version, (2) considered to be more readable, and (3) that did not suffer in terms of visual aesthetics.

The results for the second variant of the survey underscored the importance of the layout distortion objective and the impact visual distortions can have on end users' perception of a page's attractiveness.

The results showed that the users preferred to use the original, non-mobile friendly version, in 22 out of 38 subjects and preferred to use the repaired version for only 16 subjects. Readability showed similar results as the first survey variant. On average, an improvement of 11% in readability was observed for the repaired pages compared to the original versions, and was still found to demonstrate statistical significance (p-value=7.54×10−<0.05). This is expected as the enlarged font sizes can make the text very readable in the repaired versions despite layout distortions. However, in this survey a statistical significance (p-value=2.20×10−16<0.05) was observed for the attractiveness of the original version being rated higher than the repaired version. On average, the original version was rated 6.82 (median 7.00) and the repaired version was rated 5.64 (median 5.63). In terms of the effect size metric, the repaired version was rated to have a better attractiveness only 38% of the time. These results strongly indicate that the layout distortion objective plays an important role in generating patches that make the pages more attractive to end users.

The experiments described herein and their corresponding results demonstrate the effectiveness of the systems and methods described herein for automatically repairing mobile friendly issues of webpages in a technical, computationally-improved, and computationally-efficient manner. The experiments described herein also demonstrate that the technology being improved is technical, computer-dependent, and Internet-based technology.

Exemplary embodiments of the methods/systems have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

What is claimed is:

1. A method for repairing an internationalization presentation failure in a webpage when translating the webpage from a first language to a second language, the method comprising:
grouping elements of the webpage into sets of stylistically similar elements;
determining one or more potentially faulty elements in the webpage translated to the second language which are potential causes of the internationalization presentation failure;
determining one or more potentially faulty sets from the sets of stylistically similar elements, the one or more potentially faulty sets containing the one or more potentially faulty elements in the webpage;
determining candidate solutions comprising adjustments to a plurality of cascading style sheet (CSS) properties of the one or more faulty sets;
determining an optimized candidate solution from the candidate solutions; and
automatically applying the optimized candidate solution to the website to automatically generate a repaired version of the website translated into the second language.

2. The method of claim 1, wherein the grouping of the elements of the webpage into sets of stylistically similar elements comprises performing a density-based clustering technique that identifies sets of elements that are close to each other, according to a distance function, and groups the sets of elements into a cluster.

3. The method of claim 2, wherein the distance function is based on:
visual similarity based on at least one of matching of element height, matching of element width, matching of element alignment, or similarity of element CSS properties, and document object model similarity based on at least one of matching of element tag name, similarity of element XPath, or similarity of element class attribute.

4. The method of claim 1, wherein determining the candidate solutions includes a candidate solution process including:
generating a plurality of initial candidate solutions,
determining a best candidate solution from the plurality of initial candidate solutions based on a fitness function evaluation of each candidate solution from the plurality of candidate solutions,
determining an improved candidate solution based on an iterative adjustment of CSS properties of the best candidate solution,
determining mutational candidate solutions by randomly adjusting the CSS properties of the plurality of initial candidate solutions and the improved candidate solution, and
determining a plurality of top candidate solutions from the initial candidate solutions, the improved candidate solution, and the mutational candidate solutions; and
iteratively repeating the candidate solution process until a maximum number of iterations are performed or when there is no improvement in the top candidate solutions for multiple consecutive iterations.

5. The method of claim 4, wherein the fitness function evaluation is based on:
an amount of dissimilarity between a version of the webpage in the second language applying a particular candidate solution, and
an amount of change between the webpage in the second language and the version of the webpage in the second language applying the particular candidate solution.

6. The method of claim 4, wherein generating the plurality of initial candidate solutions comprises:
determining an average amount of text expansion in the elements of a particular faulty set,
generating a first candidate solution having an increased width based on the average amount of text expansion,
generating a second candidate solution having an increased height based on the average amount of text expansion,
generating a third candidate solution having a decreased font size based on the average amount of text expansion,
generating a mutated first candidate solution by randomly adjusting a width of the first candidate solution,
generating a mutated second candidate solution by randomly adjusting a height of the second candidate solution, and
generating a mutated third candidate solution by randomly adjusting a font size of the third candidate solution.

7. The method of claim 6, wherein the random adjustment of the first candidate solution, the random adjustment of the second candidate solution, and the random adjustment of the third candidate solution are based on a Gaussian distribution around a respective previous value.

8. A method for repairing cross browser issues of a website resulting from a one or more layout differences between an intended layout rendered on a first web browser and a faulty layout rendered on a second web browser, the method comprising:
detecting the one or more layout differences between the intended layout and the faulty layout of the website;
identifying, for each of the one or more layout differences, a plurality of root causes of the layout difference;
determining, for each of the identified root causes, a candidate fix that reduces the layout difference, such that a plurality of candidate fixes for addressing the one or more layout differences is determined;
determining an optimized combination of candidate fixes from the plurality of candidate fixes that most reduces the one or more layout differences; and
automatically applying the optimized combination of candidate fixes to the website to automatically generate a repaired version of the website.

9. The method of claim 8, wherein each of the one or more layout differences is associated with a layout difference tuple including a label, a first element, and a second element, the label describing a layout position of the first element relative to the second element, and
wherein the identifying of the plurality of root causes of each of the one or more layout differences comprises:
determining, for a particular layout difference having an associated particular layout difference tuple, a cascading style sheet (CSS) property corresponding to the label of particular layout difference tuple,
generating a first root cause including the first element of the particular layout difference tuple, the CSS property corresponding to the label of particular layout difference tuple, and a value of the CSS property of the first element from the faulty layout,
generating a second root cause including the second element of the particular layout difference tuple, the CSS property corresponding to the label of particular layout difference tuple, and a value of the CSS property of the second element from the faulty layout.

10. The method of claim 8, wherein each root cause includes an element of the webpage, a cascading style sheet (CSS) property associated with the element, and a value of the CSS property, and
wherein each candidate fix includes a new value for the element identified in the corresponding root cause.

11. The method of claim 10, wherein determining the candidate fix that reduces the particular layout difference for a particular root cause comprises:
performing, for the particular root cause, a plurality of exploratory moves of the element in the root cause by adjusting the value of the CSS property corresponding to the element,
evaluating each exploratory move according to a fitness function that provides a fitness value representing a deviation between a layout incorporating the exploratory move and the intended layout, and
determining a move from the plurality of exploratory moves that most reduces the particular layout difference.

12. The method of claim 11, wherein the fitness function is based on a weighted sum of a difference in location of the element, a difference in size of the element, and a difference in location of neighboring elements of the element.

13. The method of claim 8, wherein determining the optimized combination of candidate fixes from the plurality of candidate fixes comprises:
assembling a plurality of repairs, each repair including a combination of candidate fixes from the plurality of candidate fixes, and evaluating each repair in the plurality of repairs based on a number of remaining layout differences after applying the repair to the website.

14. A method for repairing display and usability issues in a webpage when viewed on a mobile device, the method comprising:
identifying one or more segments present in the webpage;
identifying one or more elements in each of the one or more segments that are causing the display and usability issues in the webpage when viewed on the mobile device;
identifying cascading style sheet (CSS) properties associated with the one or more identified elements;
determining a set of possible adjustments to the CSS properties associated with the one or more identified elements that resolve at least a portion of the display and usability issues;
determining an optimized adjustment from the set of possible adjustments; and
automatically applying the optimized adjustment to the website to automatically generate a repaired version of the website.

15. The method of claim 14, wherein the one or more segments are identified by analyzing a document model tree of the webpage using an automated clustering-based partitioning algorithm.

16. The method of claim 14, wherein the one or more elements in each of the one or more segments that are causing the display and usability issues are identified by a detector or testing tool configured to detect whether there are any display or usability issues in the webpage.

17. The method of claim 16, wherein the detector or testing tool is further configured to identify what types of display or usability issues are present, and map each problem to a corresponding HTML element.

18. The method of claim 14, further comprising identifying one or more problem types associated with each of the one or more segments that are causing the display and usability issues in the webpage when viewed on the mobile device, and
wherein the CSS properties associated with the one or more identified elements are identified based on a property dependence graph that, for a given segment and a problem type, models style relationships among HTML elements of the webpage based on CSS inheritance and style dependencies

19. The method of claim 14, wherein determining the set of possible adjustments to the CSS properties associated with the one or more identified elements comprises generating a set of versions of the webpage each having a unique adjustment to the one or more identified elements, the unique adjustments being randomly generated.

20. The method of claim 14, wherein determining the optimized adjustment comprises:
applying each of the set of possible adjustments to the webpage to generate a set of possible new webpages,
for each adjusted webpage of the set of possible new webpages, determine a weighted sum of a mobile-friendliness score of the adjusted webpage and an amount of change between the webpage and the adjusted webpage, the weighted sum being proportional to the mobile-friendliness score and inversely proportional to the amount of change between the webpage and the adjusted webpage.
